(19) United States
(12) Patent Application Publication
(10) Pub. No.: US 2006/0036357 A1
(43) Pub. Date: Feb. 16, 2006

(54) General drive control system and generat drive control method

(75) Inventors: Hiroshi Isono, Toyota-shi (JP); Yasuji Mizutani, Susono-shi (JP); Takayuki Yamamoto, Aichi-gun (JP); Koichi Takeuchi, Toyota-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Aichi-ken (JP)

(21) Appl. No.: 10/527,682

(22) PCT Filed: Sep. 10, 2003
(86) PCT No.: PCT/JP03/11595

§ 371 Date: Mar. 11, 2005

(30) Foreign Application Priority Data
Sep. 17, 2002 (JP) 2002-270582

(51) Int. Cl. G06F 17/00

(52) U.S. Cl. 701/22

(57) ABSTRACT

In a vehicle including a plurality of actuators and an energy source common to the actuators and accomplishing work by an operation of the plurality of actuators consuming energy supplied from the energy source, drive of the plurality of actuators is optimized from the viewpoint of saving energy consumed by the plurality of actuators. The general driving method includes the steps of determining, for each actuator, power to meet driving request as a desired power DMP, determining electric power to be supplied to each actuator to realize the desired power as required electric power REP, and when total required electric power REPsum as a sum of required electric powers determined for the plurality of actuators exceeds an allowable power AMP, decreasing, for some of the actuators, the corresponding desired power to establish the desired power for each of the plurality of actuators.

### TECHNICAL FIELD

The present invention relates to a technique for controlling, in a machine including a plurality of actuators and an energy source common to the actuators, drive of the plurality of actuators. More specifically, the present invention relates to a technique for optimizing drive of the plurality of actuators from the viewpoint of saving energy consumed by the plurality of actuators.

### BACKGROUND ART

In a machine for work, energy is consumed to accomplish the work. The energy necessary therefor may be supplied externally, or the machine itself may have an energy source and supply the energy by itself.

In any case, the energy that can be consumed by the machine is limited in today's world where resources and energy must be saved. Therefore, it is strongly desired to realize target state of operation and to save consumed energy simultaneously in one same machine.

There may be a case where the machine has a plurality of actuators and the actuators are driven together. In that case, it is not an easy task to realize target state of operation and to save energy consumption simultaneously. It is theoretically possible to pre-set energy source capacity so as to prevent exhaustion even when all the actuators are driven at one time. This approach, however, is not practical from the economical viewpoint and from physical viewpoint such as weight and size.

A technique for general management of a plurality of actuators in a motor vehicle as a machine, having fuel as an energy source and an engine, a brake apparatus, steering apparatus and the like as the plurality of actuators has been proposed (for example, in Japanese Patent Laying-Open No. 5-85228).

Even when the prior art technique is implemented, the amount of energy consumed by the plurality of actuators when they are driven together can not be taken into consideration. Therefore, it is not possible by the prior art technique to optimize drive of the plurality of actuators from the viewpoint of saving energy consumption.

Therefore, an object of the present invention is to optimize drive of the plurality of actuators from the viewpoint of saving energy consumed by the plurality of actuators.

### DISCLOSURE OF THE INVENTION

The present invention may be implemented in the following manners. These manners will be described as separate aspects, each aspect will be denoted by an aspect number, and aspect number of other aspect or aspects may be referred to as needed. Such description is intended to facilitate understanding of the technical features and combinations thereof that will be discussed in the specification, and not to limit the technical features and combinations thereof discussed in the specification to the aspects below.

(1) A general drive control system, provided in a machine including a plurality of actuators and an energy source common to the actuators, and accomplishing amount of work (hereinafter referred to work) by the operation of the plurality of actuators consuming energy supplied from the energy source, including
a control apparatus generally controlling drive of the plurality of actuators based on power or work of each of the plurality of actuators.

In the present system, in view of the power or work of each of the plurality of actuators, drive of the plurality of actuators is generally controlled. Here, a relation holds between the power or work of each actuator and energy consumption that the smaller the power or work, the smaller the energy consumption.

Therefore, according to the present system, as the power or work of each actuator is noted, it becomes possible to optimize the drive of the plurality of actuators from the view point of saving energy consumed by the plurality of actuators.

In the present aspect, “actuator” may be a force generating apparatus utilizing electromagnetic force (such as a rotary motor or a linear motor), driven by consuming electric energy as the energy, or an engine driven by combustion of fuel as the energy.

Here, a “motor” may be considered as an actuator that converts electric energy to mechanical energy, while an “engine” may be considered as an actuator that converts combustion energy to mechanical energy.

In the present aspect, “power” refers to the quantity of work per unit time. When each actuator converts electric energy to mechanical energy, the “power” is represented as electric power when viewed from the side of electric energy (input side of the actuator) and it may be represented as dynamic power (power or horsepower) when viewed from the side of mechanical energy (output side of the actuator).

The electric power is calculated as a product of voltage and current. The dynamic power is mechanical power, and when the machine itself is moved by an actuator such as in the case of a motor vehicle, it is calculated as a product of force exerted by the actuator on the moving body and the velocity of the moving body.

In the present aspect, “work” means time-integration of power. When the power is electrical, it is represented as watt-hour (or wattage W·h).

In the present aspect, a “machine” may be a moving body itself that moves by the operation of the actuators, or it may be a moving apparatus for moving an object different from the machine itself.

(2) The general drive control system according to aspect (1) wherein the control apparatus generally controls drive of the plurality of actuators based on total power or total work as the sum of powers or works of the plurality of actuators substantially at the same time period.

In this system, drive of the plurality of actuators are generally controlled based on total power or total work as the sum of powers or works of the plurality of actuators substantially at the same time period.

Therefore, according to the system, as the total power or total work of the plurality of actuators is noted, it becomes possible to optimize the drive of the plurality of actuators in relation to the saving of energy consumed by the plurality of actuators.

(3) The general drive control system according to aspect (1) or (2), wherein the control apparatus generally controls drive of the plurality of actuators such that the power or work of each of the actuators or the total power or total work of the plurality of actuators does not exceed an allowable value.

According to this system, it becomes possible to manage total sum of energy consumed by the plurality of actuators, by comparing the power or work of each actuator or total power or total work of the plurality of actuators with the allowable value.

(4) The general drive control system according to aspect (3), wherein the control apparatus includes a power limiting unit limiting power of at least a part of the plurality of actuators, in accordance with an order set in advance for the plurality of actuators, when the total power or total work is to exceed the allowable value.

According to this system, an order is set in advance for the plurality of actuators, and in accordance with the order, power of at least a part of the plurality of actuators is limited.

Here, the order may be set considering function usage of each actuator. When the machine is a motor vehicle, for example, the order may be set in relation to the degree of contribution of each actuator to the safety of the motor vehicle.

As a result, according to the system of this aspect, drive of a part of the plurality of actuators is limited as compared with drive of other part of the actuators in accordance with the order set in advance, so as to prevent the total power or total work from exceeding the allowable value.

Therefore, according to the present system, it becomes easier to realize target state of operation of the machine and to save energy consumption simultaneously.

(5) The general drive control system according to aspects (1) to (4), further including a driving request determining apparatus determining a driving request for the machine, wherein the control apparatus determines the power or the work based on the determined driving request to be the desired power or desired work, and based on the determined desired power or desired work, generally controls drive of the plurality of actuators.

In this system, from the driving request, the target value of each actuator is determined and represented in the dimension of power or work, and based on the desired power or desired work as the determined target value, drive of the plurality of actuators is generally controlled.

Therefore, according to this system, it becomes easier to meet the driving request while satisfying the demand for saving energy consumption.

In this aspect, “driving request” means, when the machine is a moving body moving in a certain direction, a force or acceleration (or amount of change thereof) acting on the moving body in a direction parallel to or crossing the direction of progress of the moving body, velocity (or amount of change thereof) of the moving body, position (or amount of change thereof) of the moving body or direction of movement (or amount of change thereof) of the moving body.

(6) The general drive control system according to aspect (5), wherein the driving request determining apparatus includes
a driving information detector detecting at least one of an instruction of a driver driving the machine, state of operation of the machine and operation environment in which the machine is placed, as driving information, and
a driving request determining unit determining the driving request based on the detected driving information, and
the control apparatus generally controls drive of the plurality of actuators based on the power or work based on the determined driving request.

In this system, based on at least one of the instruction of a driver driving the machine, the state of operation of the machine and the operation environment in which the machine is placed, the driving request for the machine is determined. Further, based on the power or work of each actuator based on the determined driving request, drive of the plurality of actuators is generally controlled.

Therefore, according to the present system, it becomes possible to optimize drive of the plurality of actuators from the viewpoint of saving energy consumption, considering at least one of the instruction of a driver driving the machine, the state of operation of the machine and the operation environment in which the machine is placed.

(7) The general drive control system according to aspect (5) or (6), wherein the control apparatus determines, based on the determined driving request, the power or work to meet the driving request as a desired power or desired work for each of the actuators, and based on the determined desired power or desired work, generally controls the drive of the plurality of actuators.

According to this system, the driving request and each actuator are related to each other on the control logic in the dimension of power or work, and as a result, each actuator is driven to meet the driving request from the viewpoint of power or work.

Therefore, according to this system, it becomes easier to meet the driving request and to save energy consumption simultaneously.

(8) The general drive control system according to aspects (5) to (7), wherein the control apparatus includes
a desired power determining unit determining power to meet the determined driving request as desired power, for each of the actuators,
a required electric power determining unit determining electric power to be supplied to each of the actuators to realize the desired power determined for each of the actuators, as required electric power,
a desired power establishing unit establishing desired power for respective ones of the actuators, by reducing, for some of the plurality of actuators, corresponding desired power, when total required electric power as a sum of the required electric powers determined for the plurality of actuators exceeds the allowable value, and
a driving unit driving the plurality of actuators based on the established desired power.

According to this system, by the technique of limiting power of some of the actuators while considering the driving request, it becomes easier to meet the driving request and to save energy consumption simultaneously.

(9) The general drive control system according to aspect (8), wherein the desired power establishing unit reduces the desired power determined for some of the actuators, in accordance with an order set in advance for the plurality of actuators, when the total required electric power exceeds the allowable value.

According to this system, functions and effects similar to those attained by the system of aspect (4) can be attained.

(10) The general drive control system according to any of aspects (5) to (7), wherein the control apparatus includes
a desired power determining unit determining, for each of the actuators, power to meet the determined driving request to be desired power,
a desired work determining unit determining, for each of the actuators, desired work based on the determined desired power,
a total work determining unit determining a total sum of a plurality of desired works determined for the plurality of actuators respectively, as total work,
a desired power establishing unit establishing desired power for each of the plurality of actuators by reducing, for some of the plurality of actuators, corresponding desired power, when the determined total work exceeds the allowable value, and
a driving unit driving the plurality of actuators, based on the established desired power.

In this system, it becomes possible to meet the driving request and to save energy consumption simultaneously, by the technique of limiting power of some of the actuators, in accordance with a mechanism that is fundamentally similar to the system of aspect (8).

In the system according to aspect (8) described above, energy consumption is saved by the comparison between the power and the allowable value, while in the system of the present aspect, it becomes possible to save energy consumption by the comparison between the work and the allowable value.

(11) The general drive control system according to aspect (10), wherein the desired work establishing unit reduces the desired work determined for some of the actuators, in accordance with an order set in advance for the plurality of actuators, when the total work exceeds the allowable value.

According to this system, functions and effects similar to those attained by aspect (4) can be attained.

(12) The general drive control system according to aspect (10) or (11), wherein the driving unit determines, for each of the actuators, electric power to be supplied to each actuator as supplied electric power, based on the established desired power, and drives each of the actuators with the determined supplied electric power.

In this system, each actuator is driven based on the supplied electric power determined based on the desired power established for each actuator.

(13) The general drive control system according to any of aspects (3) to (12), wherein the control apparatus includes a control mode changing unit manually or automatically changing the allowable value, for changing control mode for controlling the plurality of actuators.

In the system according to aspect (3), drive of the plurality of actuators is generally controlled such that the total power or total work does not exceed the allowable value.

Though the allowable value here may be defined as a fixed value, it is desirably defined as a variable value, in order to flexibly meet various requests, conditions or environments.

That the allowable value is made variable means that the control mode controlling the plurality of actuators is also made variable.

Therefore, in the system according to this aspect, the allowable value is manually or automatically changed, and the control mode controlling the plurality of actuators is changed thereby.

In this aspect, the “control mode changing unit” may be operated in a manner in which the allowable value is automatically changed based on the state of operation of the machine, or a manner in which the allowable value is automatically changed based on the operation environment in which the machine is placed.

The “control mode changing unit” may be operated, when the allowable value is a remaining capacity of the energy source or a variable value that changes based on a physical value related to the remaining capacity, in such a manner that the pattern of change of the allowable value based on the remaining capacity or the related physical value is manually or physically changed.

When the term “remaining capacity” is defined to mean remaining amount of electric power (for example, state of charge SOC that will be described later) remaining in the energy source, “related physical amount” here may be defined as a gradient of decrease of the remaining amount of electric power decreasing with time. The gradient means the amount of decrease of the electric power per unit time, assuming that the remaining amount of electric power is consumed in a set time.

(14) The general drive control system according to aspect (13), wherein the control mode changing unit selects as the control mode an economy mode in which saving of energy consumed by the plurality of actuators is given higher priority than realization of a target state of operation of the machine, by setting the allowable value to a small value, in a normal state of operation of the machine, and selects as the control mode a power-mode in which realization of the target state of operation of the machine is given higher priority than the saving of energy consumption, by setting the allowable value to a large value, in an emergency state of operation of the machine, and
the control apparatus generally controls drive of the plurality of actuators in accordance with the selected control mode.

In this system, drive of the plurality of actuators is generally controlled such that saving of energy consumption is given higher priority than realization of target state of operation of the machine when the machine operates in a normal state, and drive of the plurality of actuators is generally controlled such that realization of the target state of operation is given higher priority than saving of energy consumption when the machine operates in an emergency state.

Therefore, according to the present system, the state of driving a plurality of actuators can flexibly be adapted to the change in the state of operation of the machine.

(15) The general drive control system according to any of aspects (1) to (14), wherein
the plurality of actuators constitute a consumption unit consuming energy supplied from the energy source;
the energy source includes
a generating unit generating the energy, and
a storage unit storing the generated energy; and
the control apparatus includes an apparent value determining unit determining an apparent value of the power or the work based on actual power or actual work of each of the actuators, energy generation ratio or energy generation amount by the generating unit, and energy storage ratio or storage amount by the storage unit, and
a control unit generally controlling drive of the plurality of actuators, based on the determined apparent value.

In this system, when the energy source has a generating unit and a storage unit, an apparent value of power or work is determined based on the actual power or work of each actuator, energy generation ratio or generation amount by the generating unit, and the energy storage ratio or storage amount by the storage unit.

Further, based on the determined apparent value, drive of the plurality of actuators is generally controlled.

Therefore, according to this system, the energy consumed by the plurality of actuators is represented through apparent power or work, and therefore, it becomes possible to optimize drive of the plurality of actuators in consideration of not only the actual power or work of each actuator but also the energy generation ratio or generation amount by the generating unit and the energy storage ratio or storage amount by the storage unit.

In this aspect, “generating unit” may be an alternator driven by an engine, a fuel cell converting fuel into electric energy, an electric power generator driven by an engine for generating electric power dedicatedly, or a vehicle motor driving wheels and acting as a dynamic power source at the time of acceleration and acting as an electric power generator to regenerate electric power at the time of breakage, when the machine is a motor vehicle. The vehicle motor functions as a consuming unit at the time of acceleration and functions as a generating unit at the time of breakage.

In the present aspect, “storage unit” may be formed as a fuel tank, for example, when the energy is related to fuel. When the energy is electric energy, the “storage unit” may be formed as a battery (secondary battery). When the energy is related to pressure, the “storage unit” may be formed as an accumulator. When the energy is thermal energy, the “storage unit” may be formed as a heat reservoir.

(16) The general drive control system according to any of aspects (1) to (15), wherein the control apparatus includes a master control unit provided common to the plurality of actuators and generally managing the plurality of actuators, and the master control unit generally controls drive of the plurality of actuators based on the power or the work.

In this system, by the master control unit that is common to the plurality of actuators, the plurality of actuators are generally managed.

Therefore, according to the present system, it becomes easier to adjust relation between each of the plurality of actuators as compared with individual management of each actuator.

(17) The general drive control system according to aspect (16), wherein the master control unit enables realization of the target state of operation of the machine by the plurality of actuators and saving of energy consumed by the plurality of actuators.

According to this system, it becomes possible by the master control unit to optimize drive of the plurality of actuators both from the viewpoint of realization of target state of operation of the machine and the viewpoint of saving energy consumption.

(18) The general drive control system according to aspect (16) or (17), wherein the control apparatus includes a plurality of individual control units connected to the master control unit and individually controlling each of the actuators, and each individual control unit communicates with the master control unit.

According to this system, the master control unit controls each actuator through each individual control unit.

In this aspect, the relation between the “master control unit” and “individual control unit” may be such that, considering a flow of a series of data or signals for driving the actuators, the master control unit is positioned at an upstream side and the individual control units are positioned at a downstream side, and the individual control unit may operate in accordance with an instruction from the master control unit.

Here, the individual control unit may operate fully and always dependent on the master control unit, or it may be allowed to operate independently of the master control unit as needed.

(19) The general drive control system according to any of aspects (16) to (18), further including an energy detector provided for each of the actuators, for detecting at least one of input energy input to each actuator and an output energy output from each actuator, connected to the master control unit and to the individual control unit corresponding to each of the actuators.

According to this system, for each actuator, at least one of the energy input thereto and energy output therefrom is detected. The result of detection may be transmitted to the master control unit and the corresponding individual control unit.

When the system is implemented, it is not essential that the energy detector corresponding to each of the actuators is connected directly to the master control unit and the corresponding individual control unit, and the detector may be connected to one through the other.

An example of the “energy detector” of the present aspect may be a detector that detects an input electric power to the actuator or an input electric power amount as time-integration thereof, when the input energy to the actuator is electric energy. When the output energy from the actuator is mechanical energy, the detector may be a detector detecting power of the work accomplished by the actuator, or the work as time-integration thereof.

(20) The general drive control system according to any of aspects (1) to (19), wherein the work is classified into at least one of force, heat, sound and light.

(21) The general drive control system according to any of aspects (1) to (20), wherein the machine is a moving body that itself moves, by the operation of at least part of the plurality of actuators.

In this aspect, the “moving body” may be a motor vehicle, an airplane, a train, ship, or the like.

When a motor vehicle is selected as the moving body, an actuator for a driving apparatus driving the motor vehicle, an actuator for an electric steering apparatus for steering the motor vehicle, an actuator for an electric brake for braking the motor vehicle, an actuator for an air conditioner for air-conditioning the room of the motor vehicle, a light for illuminating the inside or outside of the motor vehicle and the like may be selected as the “plurality of actuators” mentioned in aspect (1).

Here, the “actuator for a driving apparatus” includes, by way of example, an engine, a motor or the like as a dynamic power source actuator, and further includes an actuator for transmission (for example, a motor for electrical transmission, or an electromagnetic valve for fluid type transmission).

Further, the “actuator for an electric steering apparatus” includes, by way of example, a motor. The “actuator for an electric brake” includes, by way of example, a motor, an electromagnetic valve for controlling fluid pressure or the like. Further, the “actuator for an air conditioner” includes, by way of example, a motor for driving a compressor of a cooler of the air conditioner.

In addition, in aspect (1), the “machine” may be an electric power generator utilizing waterpower, firepower, wind power, sunlight, tidal power or the like; an electric appliance for home use using a motor; or an energy management apparatus managing energy in a facility such as factory, office or home (by way of example, an energy managing apparatus that manages, for the unit facility, generation, consumption and storage of energy).

(22) A general drive control method executed in a machine including a plurality of actuators and an energy source common to the actuators, and accomplishing work by an operation of the plurality of actuators consuming energy supplied from the energy source, including a control step of generally controlling drive of the plurality of actuators based on power or work of each of the plurality of actuators.

According to this method, based on the mechanism similar to that of aspect (1), similar effects can be attained.

Description, interpretation and examples described with respect to the aspects above are applicable to various terms used in this aspect.

(23) The general drive control method according to aspect (22), wherein, in the control step, drive of the plurality of actuators are generally controlled based on total power or total work as a sum of power and work of the plurality of actuators substantially at the same time period.

According to this method, based on the mechanism of the system similar to that of aspect (2), similar effects can be attained.

In addition, the method in accordance with the present aspect and the previous aspect may be implemented in the manner for implementing the system in accordance with any of the aspects (3) to (21) described above. Specifically, the method in accordance with the present aspect and the previous aspect may be implemented with technical characteristics described in any of aspects (3) to (21) grasped from the viewpoint of the method.

(24) The general drive control method according to aspect (22), wherein
the machine is a moving body used by a human being, and
the control step includes a distribution step of distributing among the plurality of actuators, available power or available work, which is the power or work that can be supplied by the energy source to the plurality of actuators as a whole, based on a safety variable related to safety of the moving body, a comfort variable related to comfort enjoyed by the human being using the moving body, and an economy variable related to economy of energy consumption by the plurality of actuators.

According to this method, when the “machine” of aspect (22) is a moving body used by a human being, it becomes easier to appropriately distribute available power or available work, which is the power or work that can be supplied by the energy source to the plurality of actuators as a whole, considering safety of the moving body, comfort of the moving body when the human being uses the moving body, and economy of energy consumption by the plurality of actuators.

### BRIEF DESCRIPTION OF THE DRAWINGS

FIG. 1 is a block diagram schematically representing a general drive control system in accordance with a first embodiment of the present invention and a motor vehicle mounting the system.

FIG. 2 is a functional block diagram representing the general drive control system shown in FIG. 1.

FIG. 3 is a block diagram specifically showing the general drive control system and the motor vehicle of FIG. 1.

FIG. 4 represents components of the motor vehicle shown in FIG. 3, classified from the viewpoint of energy flow.

FIG. 5 is a cross sectional front view showing a vehicle motor 58, an electrically driven CVT apparatus 62 and a CVT motor 66 shown in FIG. 3.

FIG. 6 is a block diagram schematically representing a hardware configuration of a master ECU 18 shown in FIG. 3.

FIG. 7 is a flow chart schematically representing contents of a general drive control program of FIG. 6.

FIG. 8 is a graph representing the contents to be executed in S6 of FIG. 7.

FIG. 9 is another graph representing the contents to be executed in S6 of FIG. 7.

FIG. 10 is a graph representing the contents to be executed in S7 of FIG. 7.

FIG. 11 is another graph representing the contents to be executed in S7 of FIG. 7.

FIG. 12 is a graph representing the contents to be executed in S9 of FIG. 7.

FIG. 13 is a flow chart schematically representing the details of S14 of FIG. 7 as a power limiting routine.

FIG. 14 is a flow chart schematically representing the contents of electric power generation control program of FIG. 3.

FIG. 15 is a graph representing an example of contents to be executed in S74 to S77 of FIG. 14.

FIG. 16 is a graph time-sequentially illustrating a result of execution of the general drive control program and the electric power generation control program shown in FIG. 3.

FIG. 17 is a flow chart schematically representing the contents of the power limiting routine executed by a computer 200 of master ECU 18 in the general drive control system in accordance with a second embodiment of the present invention.

FIG. 18 is a flow chart schematically representing the contents of the power limiting routine executed by computer 200 of master ECU 18 in the general drive control system in accordance with the third embodiment of the present invention.

FIG. 19 is a graph schematically representing the contents to be executed in the power limiting routine shown in FIG. 18.

FIG. 20 is another graph schematically representing the contents to be executed in the power limiting routine shown in FIG. 18.

FIG. 21 is a flow chart schematically representing the contents of the general drive control program executed by computer 200 of master ECU 18 in the general drive control system in accordance with the fourth embodiment of the present invention.

FIG. 22 schematically represents, by an equation, the contents to be executed of the general drive control program shown in FIG. 21.

### BEST MODES FOR CARRYING OUT THE INVENTION

In the following, some specific embodiments of the present invention will be described in detail with reference to the figures.

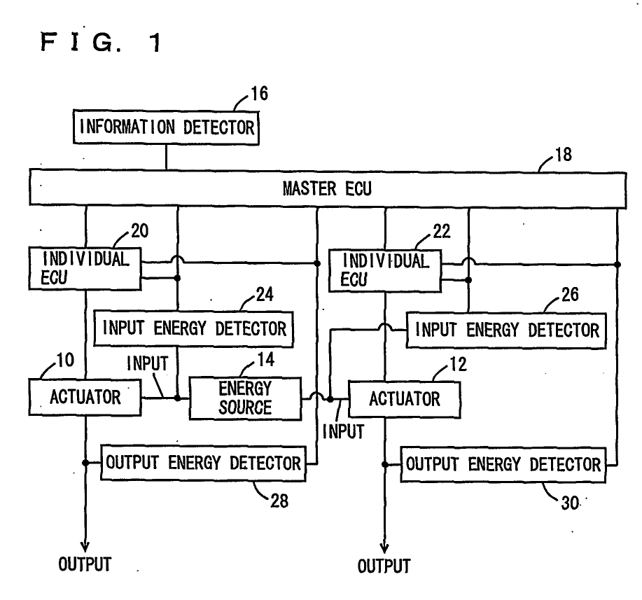

FIG. 1 is a block diagram of a hardware configuration of the general drive control system in accordance with the first embodiment of the present invention. The general drive control system is mounted on a motor vehicle (hereinafter also referred to as a vehicle) as a machine. The motor vehicle includes a plurality of actuators (in FIG. 1, represented by two actuators) 10, 12, and an energy source 14 common to these actuators.

The general drive control system includes driving information detector 16 detecting driving information, and a master ECU (Electronic Control Unit) 18. Further, the general drive control system includes, for respective actuators 10, 12, individual ECUs 20, 22, input energy detectors 24, 26 and output energy detectors 28, 30.

Driving information detector 16 is provided to detect a driver's instruction issued by the driver of the motor vehicle for driving the vehicle, state of the vehicle, and the running environment in which the vehicle is placed. Here, the “driver's instruction” includes, by way of example, an instruction related to acceleration of the vehicle, an instruction related to deceleration or brakeage, an instruction related to steering and the like.

Master ECU 18 is provided to manage the plurality of actuators 10, 12 as a whole through the plurality of individual ECUs 20, 22 corresponding to respective ones of the plurality of actuators 10, 12. In contrast, individual ECUs 20, 22 are provided to drive respective actuators 10, 12, in accordance with an instruction from master ECU 18.

Input energy detectors 24, 26 are provided to detect input energy to corresponding actuators 10, 12 or to energy source 14. Specifically, input energy detectors 24, 26 are provided to detect electric power consumption by corresponding actuators 10, 12 and to detect electric power generated by actuators 10, 12 when corresponding actuators 10, 12 function as electric power generators. In any case, the electric power is detected as a product of voltage and current of actuators 10, 12.

Output energy detectors 28, 30 are provided to detect output energy from corresponding actuators 10, 12, respectively. Specifically, output energy detectors 28, 30 are provided to detect power of the work actually accomplished by the drive of corresponding actuators 10, 12, respectively.

The power is detected as a product of force (or torque) acting on the object moved by actuators 10, 12 and the velocity (or number of rotation) of the object. When the object is a motor vehicle itself, the power is detected as a product of a value obtained by multiplying the force or acceleration acting on the vehicle and the mass, and the vehicle velocity, that is the running velocity of the vehicle.

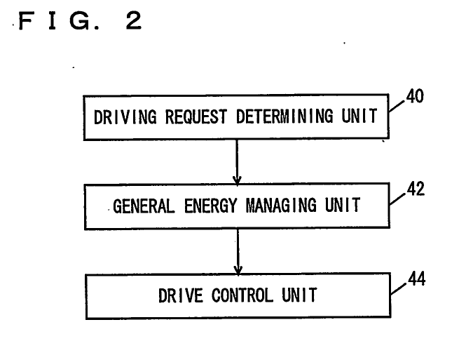

FIG. 2 shows the general drive control system in a functional block diagram. The general drive control system is configured to include, from the viewpoint of its function, a driving request determining unit 40, a general energy managing unit 42, and a drive control unit 44.

Driving request determining unit 40 is a unit for determining driving request for the vehicle to meet the driver's instruction, state of the vehicle and the running environment described above. The driving request includes, by way of example, acceleration, deceleration, amount of turn and the like of the vehicle.

General energy managing unit 42 calculates for each actuator a desired power DMP to meet the driving request described above, and based on the calculated DMP, determines an electric power to be supplied to each of actuators 10, 12 to realize the desired electric power, as required electric power REP.

General energy managing unit 42 further calculates total sum of required electric power REP determined for the plurality of actuators 10, 12 as total required electric power REPsum.

Further, general energy managing unit 42 limits desired power DMP of each of the actuators 10, 12 such that the calculated REPsum does not exceed the electric power available for the vehicle. Specifically, an order is set in advance for the plurality of actuators 10, 12, and general energy managing unit 42 limits the desired power DMP of each of the actuators 10, 12 in accordance with the order.

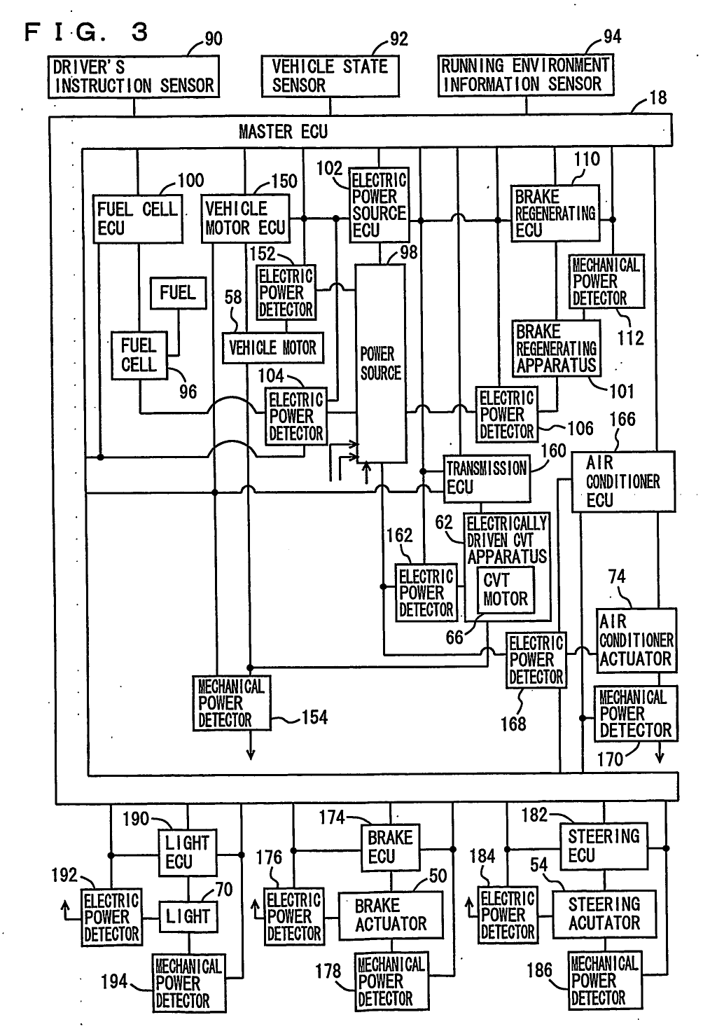

In the present embodiment, the vehicle includes, as the plurality of actuators 10, 12, the following, as shown in FIG. 3:
(1) a brake actuator 50 controlling friction brake for braking each wheel;
(2) a steering actuator 54 controlling an electric steering apparatus for steering the vehicle;
(3) a vehicle motor 58 driving the vehicle;
(4) a CVT motor 66 controlling gear ratio of electrically driven CVT apparatus 62 transmitting driving torque of vehicle motor 58 to each wheel;
(5) a light 70 of the vehicle; and
(6) an air conditioner actuator 74 for an air conditioner of the vehicle.

Break actuator 50 is, by way of example, a motor functioning as a driving source of the brake, an electromagnetic valve controlling pressure transmitted from a pressure source to the brake, and the like.

Vehicle motor 58 functions as an electric motor and a dynamic power source of the vehicle at the time of acceleration of the vehicle, and functions as an electric power generator (a regenerative motor or a brake motor) at the time of deceleration of the vehicle. For the process of recovering the electric energy generated by vehicle motor 58 and regenerating the energy by energy source 14 at the time of deceleration of the vehicle, that is, the so called brake regeneration, the vehicle has the brake regenerating apparatus. Therefore, vehicle motor 58 is regarded not only as an energy consuming unit but also as a temporal energy generating unit.

The air conditioner includes a cooler for cooling the room of the vehicle, and the actuator therefor is the air conditioner actuator 74. Air conditioner actuator 74 is, by way of example, a motor driving a compressor in the cooler.

In the present embodiment, an order is set for the plurality of actuators such that brake actuator 50, steering actuator 54, vehicle motor 58 and CVT motor 66, light 70 and air conditioner actuator 74 are controlled with priority in accordance with this order.

Therefore, in the present embodiment, when the calculated total required electric power REPsum mentioned above exceeds allowable power AMP that is the maximum value of power that can be accomplished with the available electric power EPava in the vehicle, the desired power DMP of respective actuators would be limited in accordance with an order reverse to the order of priority mentioned above.

As is apparent from the foregoing, general energy managing unit 42 is provided for energy management to realize optimal amount or ratio of distribution of the electric energy that is limited in the vehicle, to the plurality of actuators.

The relation between the available electric power EPava in the vehicle and individual amount of distribution Xi (I=1, 2, 3, . . . n) to each of the actuators can be given by a target function for optimizing electric power distribution, represented by the following equation:
EPava=ΣXi.
The target function is also a function representing the manner how the power corresponding to the electric power EPava is distributed among respective actuators, because consideration of electric power is equivalent to consideration of power.

Further, each amount of individual distribution Xi can be represented by the following equation, using the distribution ratio Ki of electric power EPava to each of the actuators:
Xi=EPava·Ki.

Therefore, by general energy managing unit 42, the distribution factor Ki for each actuator is optimised from the viewpoint of saving energy consumption, and the target function is optimized accordingly.

In the foregoing, driving request determining unit 40 and general energy managing unit 42 have been described. Remaining drive control unit 44 drives each of the actuators such that the desired power DMP finally determined by general energy managing unit 42 is realized. Drive control unit 44 monitors actual power MP of each actuator, and performs feed-back control of drive of each of the actuators. For the monitoring of power MP, power detectors 28, 30 described above are used.

FIG. 3 shows, in a block diagram, details of the hardware configuration of the general drive control system.

The general drive control system includes, as said driving information detector 16, a driver's instruction sensor 90 detecting a driver's instruction, a vehicle state sensor 92 detecting the state of the vehicle, and a running environment information sensor 94 detecting information related to the running environment.

Driver's instruction sensor 90 detects an amount of driver's operation of vehicle steering system, that is, a steering operation member, a brake operation member and an accelerator operation member, as the driver's instruction.

Vehicle state sensor 92 detects vehicle velocity, wheel velocity, vehicle driving force, vehicle acceleration, vehicle deceleration, steering angle, force or torque acting on the tire of each wheel and the like as the vehicle state.

The running environment information sensor 94 detects distance between the vehicle itself and a vehicle running ahead, state of road on which the vehicle is running, weather and temperature of the region where the vehicle is running and so on as the running environment information. Running environment information sensor 94 may be designed to estimate or predict environment of the road on which the vehicle is running or will be running in the future, through the use of GPS or through communication with a road information center.

In the present embodiment, the vehicle includes, as an energy source 14, a fuel cell 96 (an electric power generator) and a separate electric power source 98. As is apparent from the description above, vehicle motor 58 also functions temporarily as an electric power generator, and hence, it may be considered as constituting energy source 14.

Fuel cell 96 takes out fuel from a fuel tank containing substance such as hydrogen as the fuel, and generates electric power by using the taken fuel. Fuel cell 96 is managed by a fuel cell ECU 100 connected to master ECU 18. Fuel cell ECU 100 is an example of the individual ECUs 20, 22, and this applies to other system element denoted by the term ECU, except for the master ECU 18.

In contrast, electric power source 98 is formed as a battery storing electric energy that is generated by fuel cell 96 and a brake regenerating apparatus 101 that will be described later. Electric power source 98 may be formed, for example, to include a low voltage battery and a high voltage battery.

Electric power source 98 is also managed by an electric power source ECU 102 that is connected to master ECU 18, similar to fuel cell 96. The electric power (generated electric power) supplied from fuel cell 96 to electric power source 98 is detected by an electric power detector 104, while the electric power (regenerated electric power) supplied from brake regenerating apparatus 101 to electric power source 98 is detected by an electric power detector 106. Electric power detectors 104 and 106 are both connected to master ECU 18, and capable of communicating necessary information. Electric power detectors 104, 106 are examples of input energy detectors 24, 26, and the same applies to other electric power detectors that will be described later.

The vehicle includes, as the plurality of actuators, vehicle motor 58, CVT motor 66, air conditioner actuator 74, light 70, brake actuator 50, and a steering actuator 54, as described above.

In this vehicle, brakeage is realized by co-operation of the functions of brake actuator 50 and of the vehicle motor as an electric power generator. Further, in the vehicle, as the vehicle motor 58 functions as the electric power generator, the electric energy generated by the vehicle motor 58 is recovered to electric power source 98. Thus, brake regenerating apparatus 101 described above is provided on this vehicle.

Brake regenerating apparatus 101 is controlled by brake regenerating ECU 110 connected to master ECU 18 and to electric power source ECU 102. Actual load on brake regenerating apparatus 101, that is, power, is detected by a power detector 112. Power detector 112 is an example of output energy detectors 28, 30, and the same applies to other power detectors that will be described later.

Power detector 112 detects, for each wheel, the product of a brake torque acting thereon and the speed of rotation (wheel velocity), as the power. Power detector 112 is connected to brake regenerating ECU 110 and master ECU 18.

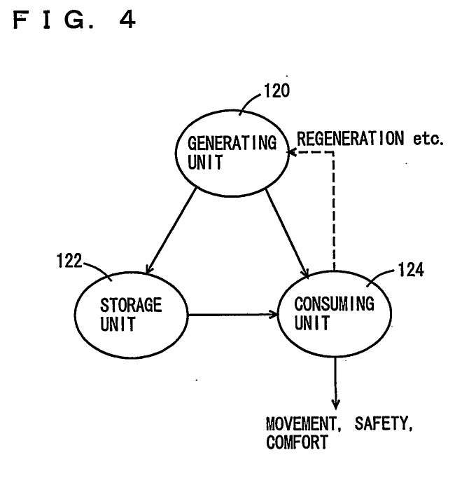

FIG. 4 schematically represents flow of electric energy of the vehicle. The vehicle includes, as a generating unit 120 generating electric energy, fuel cell 96 and brake regenerating apparatus 101. Further, the vehicle includes electric power source 98 as a storage unit 122 storing electric energy. Further, the vehicle includes a plurality of actuators as consuming unit 124 consuming the generated energy. The electric energy generated by generating unit 120 is stored in storage unit 122 while it is consumed by consuming unit 124. The electric power stored in storage unit 122 is consumed by consuming unit 124. Movement, safety and comfort of the vehicle are ensured by the consumption.

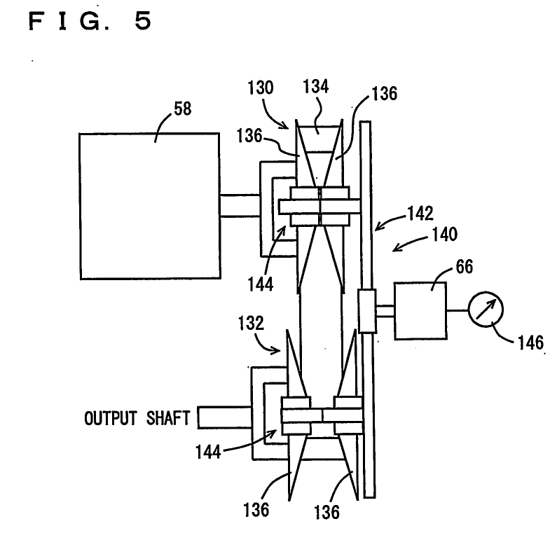

FIG. 5 is a cross sectional front view schematically showing an example of electrically driven CVT apparatus 62 provided as a transmission apparatus on the vehicle. Electrically driven CVT apparatus 62 is a belt & pulley type apparatus having a pair of pulleys 130, 132 with a belt 134 wound therearound. One pulley 130 is rotated by vehicle motor 58, and the rotation of this pulley 130 is transmitted to the other pulley 132 through belt 134. Rotation of pulley 132 is transmitted to a driving wheel of the vehicle through an output shaft, not shown, and thus the vehicle is driven.

In electrically driven CVT apparatus 62, two side surfaces of the groove of pulley 130 are formed by a pair of rotating bodies 136, 136 opposing to each other and coaxial with pulley 130. The same applies to the other pulley 132.

The pair of rotating bodies 136, 136 can be displaced relative to each other in a direction coaxial with the corresponding pulley 130, 132. In the electrically driven. CVT apparatus 62, the distance between the pair of rotating bodies 136, 136 is continuously changed by CVT motor 66 and a rotation transmitting mechanism 140, whereby the width of the groove of respective pulleys 130, 132 is changed continuously. Accordingly, the radius of belt 134 wound around respective pulleys 130, 132 is also continuously changed, and as a result, gear ratio of the speed of rotation of vehicle motor 58 is changed continuously.

Rotation transmitting mechanism 140 includes a gear train 142 as an example of a distributing mechanism that distributes the rotational motion of CVT motor 66 common to the pair of pulleys 130, 132 to each of the pulleys 130, 132, as rotational motion coaxial therewith. Further, rotation transmitting mechanism 140 includes, for each of the pulleys 130, 132, a ball spring 144 as an example of a mechanism for converting the rotational motion distributed to each of the pulleys 130, 132 by gear train 142 to relative linear motion along the axial direction of the pair of rotating bodies 136, 136.

Therefore, in electrically driven CVT apparatus 62, the gear ratio of the speed of rotation of vehicle motor 58 is determined in accordance with the angle of rotation of CVT motor 66. The angle of rotation of CVT motor 66 is detected by a rotation angle sensor 146.

As shown in FIG. 3, vehicle motor 58 is driven as the electric energy supplied from electric power source 98 is consumed. Vehicle motor 58 is controlled by a vehicle motor ECU 150 that is connected to master ECU 18 and to electric power source ECU 102. The electric power consumed by vehicle motor 58 is detected by an electric power detector 152 connected to master ECU 18, vehicle motor ECU 150 and to electric power source ECU 102.

Further, actual power of vehicle motor 58 is detected by a power detector 154 connected to master ECU 18 and to vehicle motor ECU 150. By way of example, power detector 154 detects, for each driven wheel, the power as a product of driving torque acting on the wheel and the speed of rotation of the wheel.

CVT motor 66 is also driven as the electric energy supplied from electric power source 98 is consumed. CVT motor 66 is controlled by a transmission ECU 160 that is connected to master ECU 18, electric power source ECU 102 and to vehicle motor ECU 150. The electric power consumed by CVT motor 66 is detected by an electric power detector 162 connected to master ECU 18, transmission ECU 160 and electric power source ECU 102.

Air conditioner actuator 74 is also driven as the electric energy supplied by electric power source 98 is consumed. Air conditioner actuator 74 is controlled by an air conditioner ECU 166 connected to master ECU 18. The electric power consumed by air conditioner actuator 74 is detected by an electric power detector 168 connected to master ECU 18 and air conditioner ECU 166.

Further, the actual power of air conditioner actuator 74 is detected by power detector 170 connected to air conditioner ECU 166 and master ECU 18. By way of example, power detector 170 detects the power as a product of air flow and the room temperature of the vehicle.

Brake actuator 50 is also driven as the electric power from electric power source 98 is consumed. Brake actuator 50 is controlled by a brake ECU 174 connected to master ECU 18. The electric power consumed by brake actuator 50 is detected by an electric power detector 176 connected to master ECU 18 and brake ECU 174.

Further, actual power of brake actuator 50 is detected by a power detector 178 connected to brake ECU 174 and master ECU 18. By way of example, power detector 178 detects the power for each wheel as the product of brake torque of the wheel and the speed of rotation of the wheel.

Steering actuator 54 is also driven as the electric energy supplied from electric power source 98 is consumed. Steering actuator 54 is controlled by steering ECU 182 connected to master ECU 18. The electric power consumed by steering actuator 54 is detected by an electric power detector 184 connected to master ECU 18 and steering ECU 182. Further, actual power of steering actuator 54 is detected by a power detector 186 connected to steering ECU 182 and master ECU 18.

Light 70 is also driven as the electric energy supplied from electric power source 98 is consumed. Light 70 is controlled by a light ECU 190 connected to master ECU 18. The electric power consumed by light 70 is detected by an electric power detector 192 connected to master ECU 18 and light ECU 190.

Further, the actual power of light 70 is detected by a power detector 194 connected to light ECU 190 and master ECU 18.

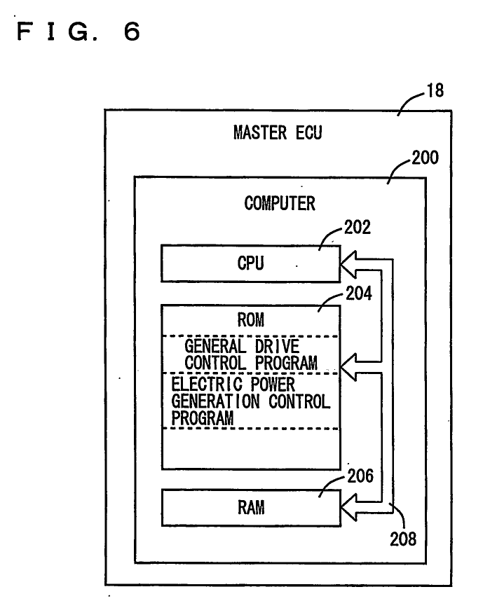

FIG. 6 is a block diagram schematically representing the configuration of master ECU 18. Master ECU 18 consists mainly of a computer 200. As is well known, computer 200 is formed by a CPU 202 (an example of a processor), an ROM 204 (an example of a memory) and an RAM 206 (another example of a memory) connected to each other by a bus 208. Various programs including the general drive control program and the electric power generation control program are stored in advance in ROM 204.

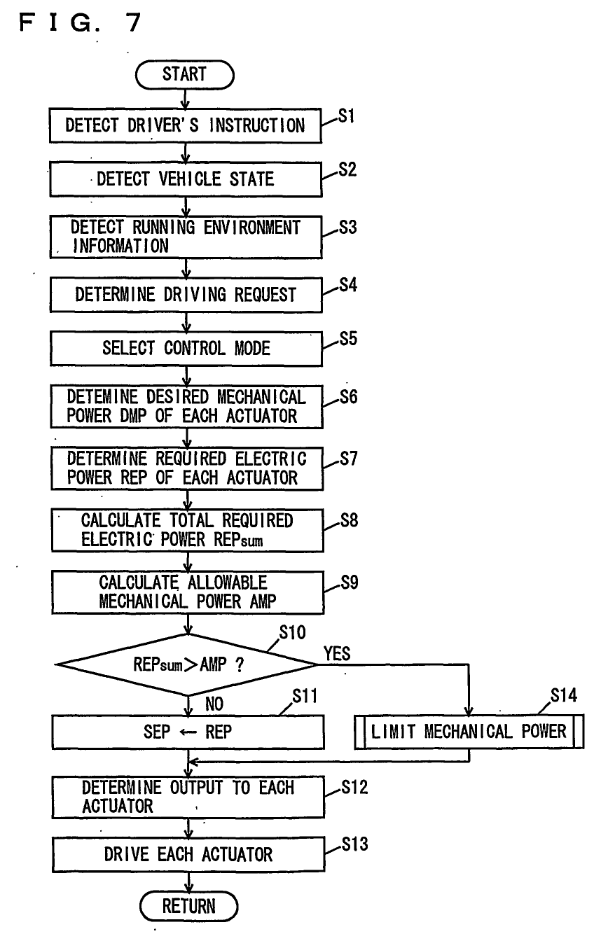

FIG. 7 represents the contents of the general drive control program in the form of a flow chart. The general drive control program is executed repeatedly while the computer 200 is on.

Every time the general drive control program is executed, first, in step S1 (hereinafter simply denoted as “S1”; same for other steps), a driver's instruction is detected by driver's instruction sensor 90. Next, in S2, the vehicle state is detected by vehicle state sensor 92. Thereafter, in S3, running environment information is detected by running environment information sensor 94.

Thereafter in S4, based on the detected driver's instruction, vehicle state and running environment information, a driving request for the vehicle is issued. The driving request includes a request for driving the vehicle in accordance with the driver's instruction and a request for automatically driving the vehicle to improve safety of the vehicle, independent of the driver's instruction. An example of the latter request is automatic brakeage that automatically brakes the vehicle, when the distance of the vehicle and a vehicle running ahead is insufficient in view of the current velocity of the vehicle.

Next, in S5, either an economy mode or a power-mode is selected as a control mode controlling the actuators. The selection may be made in accordance with the intension of the driver or it may be made automatically.

Here, the “economy mode” is a control mode in which saving of energy consumed by the actuators is given higher priority than realization of driving request by the actuators. In contrast, the “power-mode” is a control mode in which realization of the driving request by the actuators is given higher priority than saving of energy consumption by the actuators.

When the control mode is selected, by way of example, whether the vehicle is in a normal state of operation or emergency state of operation at present is determined based on a driver's instruction (for example, speed or amount of operation of a driving operation member by the driver) or based on the running environment information (for example, following distance). When it is determined that the vehicle is in a normal state, the economy mode is selected, and when it is determined that the vehicle is in an emergency state, the power-mode is selected.

Thereafter, in S6, power MP of each actuator necessary for realizing the determined driving request is calculated as the desired power DMP.

By way of example, when the determined driving request is that a vehicle having the weight of lt is accelerated with acceleration of about 0.2 G so that the vehicle velocity is increased from 0 km/h to 100 km/h in 0.25 min., the desired power DMPmtr of vehicle motor 58 is calculated to be about 54 kW, that is, the product of driving force F (=product of vehicle weight and acceleration) and the vehicle velocity V.

When the determined driving request is that a vehicle having the weight of 1t should run steadily at the vehicle velocity of 100 km/h against coasting deceleration of about 0.05 G, the desired power DMPmtr of vehicle motor 58 is calculated to be 14 kW.

It is noted that in a motor, generally, the power MP is calculated as a product of torque T and number of rotation N, and the electric power EP is calculated as a product of voltage E applied to the motor and the current I flowing through the motor. When energy loss across the motor is neglected, the power MP and the electric power EP are equal to each other.

Thereafter, in S7, electric power EP of each actuator necessary for realizing the calculated desired power DMP is calculated as the required electric power REP. In the following, this will be described specifically, taking vehicle motor 58 as an example of the actuator.

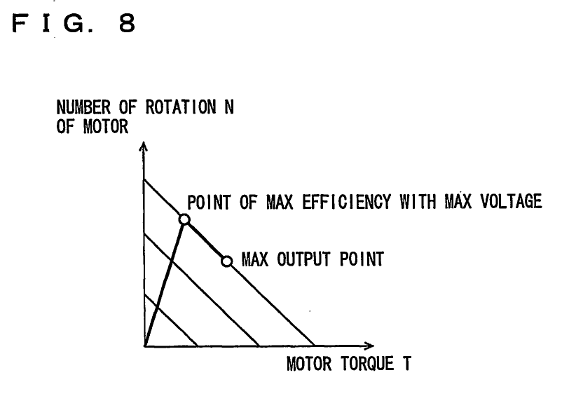

As shown in FIG. 8, for a general motor, a relation represented by a plurality of straight lines inclined downward from left to right in a graph holds between motor torque T and number of rotation N of the motor, when motor voltage E is kept constant and motor current I is changed. This is the general motor characteristic.

Among the plurality of straight lines, the maximum output point exists on the uppermost straight line of the graph. The maximum output point represents a point at which the product of motor torque T and the number of rotation N of the motor is the largest, and hence, it represents the maximum value of power MP.

When it is necessary to drive the motor with maximum power, target motor torque T* and target number of rotation N* of the motor can be determined in accordance with the motor characteristic represented by the graph of FIG. 8.

For a general motor, however, the maximum output point is not the same as the maximum efficiency point of the motor, and the point is shifted from the maximum output point to the side with smaller motor torque T and larger number of rotation N of the motor, on the uppermost straight line of the graph, as shown in FIG. 8.

Therefore, when vehicle motor 58 in a stationary state is powered on to have an intersecting point of motor torque T and the number of rotation N of the motor, that is, the point indicating power, moved from 0 to the maximum output point, it is more convenient in view of energy saving to have the point indicating power moved to the maximum efficiency point through the shortest path, then to have the motor current I increased while maintaining motor voltage E constant, so as to have the point indicating power moved from the maximum efficiency point to the maximum output point, than to have the point indicating power moved along the shortest path.

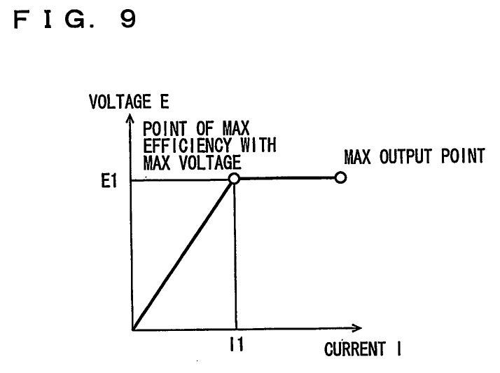

FIG. 9 is a graph representing motor current I and motor voltage E increasing with appropriate gradient, when the intersecting point of motor current I and motor voltage E, that is, the point indicating electric power P is moved from 0 through the maximum efficiency point to the maximum output point.

More specifically, first, motor current I and motor voltage E together are increased proportionally with time. By the increase, the point indicating electric power reaches the maximum efficiency point. Then, motor current I is increased proportionally with time while motor voltage E is kept constant.

The graph of FIG. 9 represents time-transition of motor current I and motor voltage E, and therefore, by utilizing this graph, it is possible to calculate in advance the electric power EP as the product of motor current I and motor voltage E at each time point.

It is noted, however, that the graph of FIG. 9 represents a relation between motor current I and motor voltage E when the desired power DMP of vehicle motor 58 is the same as the power represented by the maximum output point of FIG. 8, that is, the maximum power.

In contrast, when the desired power DMP of vehicle motor 58 is smaller than the maximum power mentioned above, motor current I and motor voltage E will be changed with time such that the intersecting point of motor torque T and the number of rotation N of the motor when the product of motor torque T and the number of rotation N of the motor matches the desired power is the final goal, in the graph of FIG. 8.

In the graph of FIG. 8, when the final goal is reached, motor voltage E at the final goal can be identified. Therefore, motor current I at the final goal can be found from the identified motor voltage E and the graph of FIG. 9.

Therefore, even when the desired power DMP of vehicle motor 58 is smaller than the maximum power mentioned above, it is possible to calculate time-transition of motor current I and motor voltage E, respectively. Therefore, it is also possible to calculate time-transition of target motor torque T* and target number of rotation N* of the motor.

In the foregoing, control of vehicle motor 58 to accelerate the vehicle has been described. In the following, control of vehicle motor 58 to decelerate the vehicle will be described.

When the vehicle is decelerated, vehicle motor 58 functions as an electric power generator (regenerating motor or a brake motor), and the vehicle is decelerated using the electric power generation resistance. It is noted, however, that target vehicle velocity and target deceleration may not be accomplished by vehicle motor 58 only. In that case, assistance of the brake is necessary.

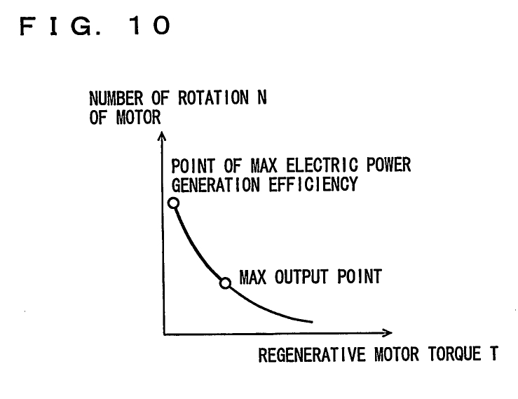

FIG. 10 is a graph schematically representing, by a curve, a relation held between regenerative motor torque T and the number of rotation N of the motor when electric power is generated by vehicle motor 58. On the curved line of the graph, there is the maximum output point of vehicle motor 58 functioning as a regenerating motor, and a point of maximum electric power generation efficiency, at which the efficiency of electric power generation by vehicle motor 58 is the highest.

Therefore, when the vehicle is decelerated, a combination of regenerative motor torque T and the number of rotation N of the motor appropriate to realize desired power DMP indicated by the driving request can be determined as a combination of target regenerative motor torque T* and the target number of rotation N* of the motor, in accordance with the characteristic represented by the curve in the graph of FIG. 10.

Thereafter, required electric power REP for the vehicle motor 58 necessary for deceleration of the vehicle is calculated in a manner similar to that for acceleration.

Vehicle motor 58 is driven when the driving request is related to acceleration or deceleration of the vehicle. In that case, control of CVT motor 66 or brake actuator 50 is necessary, in addition to control of vehicle motor 58. This will be specifically described in the following.

When the vehicle is accelerated, the vehicle velocity and the vehicle body driving force are determined by the combination of vehicle motor 58 and electrically driven CVT apparatus 62. Therefore, from the relation of said determined target number of rotation N* of the motor and the target velocity indicated by the driving request, it is possible to determine the gear ratio γ of electrically driven CVT apparatus 62. Alternatively, gear ratio γ of electrically driven CVT apparatus 62 may be determined from the relation between said determined target motor torque T* and the target vehicle body driving force indicated by the driving request.

Similarly, when the vehicle is decelerated, the vehicle velocity and the vehicle body driving force are determined by the combination of vehicle motor 58 and electrically driven CVT apparatus 62. Therefore, from the relation of said determined target number of rotation N* of the motor and the target velocity indicated by the driving request, it is possible to determine the gear ratio γ of electrically driven CVT apparatus 62. Alternatively, gear ratio γ of electrically driven CVT apparatus 62 may be determined from the relation between said determined target regenerative motor torque T* and the target vehicle body driving force indicated by the driving request.

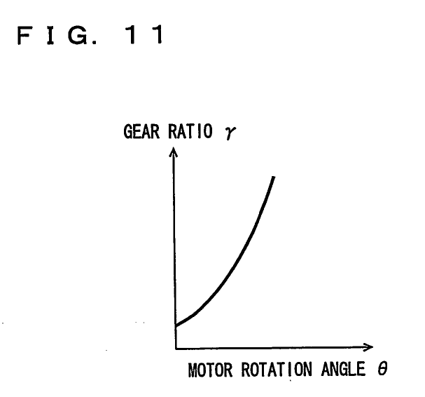

FIG. 11 is a graph representing an exemplary relation between gear ratio γ and angle of rotation θ of CVT motor 66. CVT motor 66 is driven in accordance with the characteristic shown in the graph. In S8, required electric power REP of CVT motor 66 is also calculated.

In the foregoing, contents to be executed in S7 have been described with calculation of required electric power REP for vehicle motor 58 taken as an example. By the execution of S7, eventually, required electric power REPbrk for brake actuator 50, required electric power REPstr for steering actuator 54, required electric power REPmtr for driving vehicle motor 58 that is the sum of required electric power for vehicle motor 58 and required electric power for CVT, required electric power REPlig for light 70, and required electric power REPa/c for air conditioner actuator 74 are calculated and stored in RAM 206.

Thereafter, in S8 of FIG. 7, total sum of required electric power REP for all the actuators is calculated as the total required electric power REPsum in the narrow sense. In the present embodiment, an apparent total required electric power REPsum (hereinafter simply referred to as “total required electric power REPsum”) is calculated by subtracting electric power generated by fuel cell 96 and the electric power regenerated by brake regenerating apparatus 101 from the calculated total required electric power REPsum in the narrow sense.

Thereafter, in S9, state of charge SOC of electric power source 98, that is, the remaining capacity of electric power source 98 is calculated. Here, “state of charge SOC” is a physical value representing the remaining electric power in the electric power source 98, given as percentage, with fully charged state being the reference.

In order to calculate the state of charge SOC, by way of example, the voltage of electric power source 98 and the current taken out from electric power source 98 are successively measured and integrated over time, to estimate consumed electric power (discharged electric power). Using the estimated electric power consumption, it is possible to calculate the state of charge SOC at each time point. When the estimated electric power consumption is corrected in consideration of temperature of electric power source 98 and degradation of electric power source 98, the state of charge SOC can be estimated with higher accuracy.

In S9, in accordance with the state of charge SOC calculated in this manner and the selected control mode described above, the allowable power AMP is determined. The determined allowable power AMP is stored in ROM 206.

Here, “allowable power AMP” represents the ratio of allowable consumption per minute of the state of charge SOC. The unit of the state of charge SOC is percentage, and therefore, the unit of allowable power AMP is percent/min.

Here, the state of charge SOC represents the electric power remaining in the electric power source 98 by a ratio, and hence, it is in the same dimension. Thus, allowable power AMP has the dimension resulting from division of electric power by time, and hence, it may be considered to be in the same dimension as the electric power.

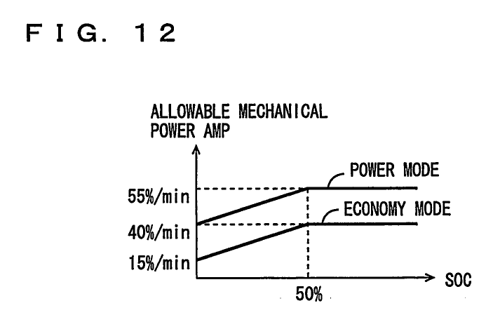

FIG. 12 is a graph showing how the allowable power AMP changes along with the state of charge SOC, and the relation therebetween that is different in the power-mode and in the economy mode. In the region where the state of charge SOC is not higher than 50%, the allowable power AMP increases together with the state of charge SOC, and when SOC exceeds 50%, the allowable power AMP is kept constant, both in the power-mode and in the economy mode. It is noted, however, that the allowable power AMP is larger in power-mode than in economy mode in the entire region of the state of charge SOC.

Thereafter, in S10 of FIG. 7, whether the total required electric power REPsum calculated in S8 exceeds the allowable power AMP determined in S9 or not is determined. If it is assumed as not exceeding here, the determination is NO, and hence, the flow proceeds to S11.

In S11, electric power EP to be supplied to each actuator is determined as supplied electric power SEP. Specifically, it is determined to be equal to the required electric power REP for each actuator calculated in S7. Thereafter, in S12, based on the determined supplied electric power SEP, the voltage to be applied to each actuator and the current to be applied to each actuator are determined, and thus, output to each actuator is determined.

Next, in S13, each actuator is driven with the determined voltage and current. Drive of each actuator is feed-back controlled with reference to the actual power detected by the corresponding power detector.

Through these steps, one execution of the general drive control program is complete.

An example in which the total required electric power REPsum does not exceed the allowable power AMP has been described. When it exceeds, the determination in S10 is YES, and the flow proceeds to S14.

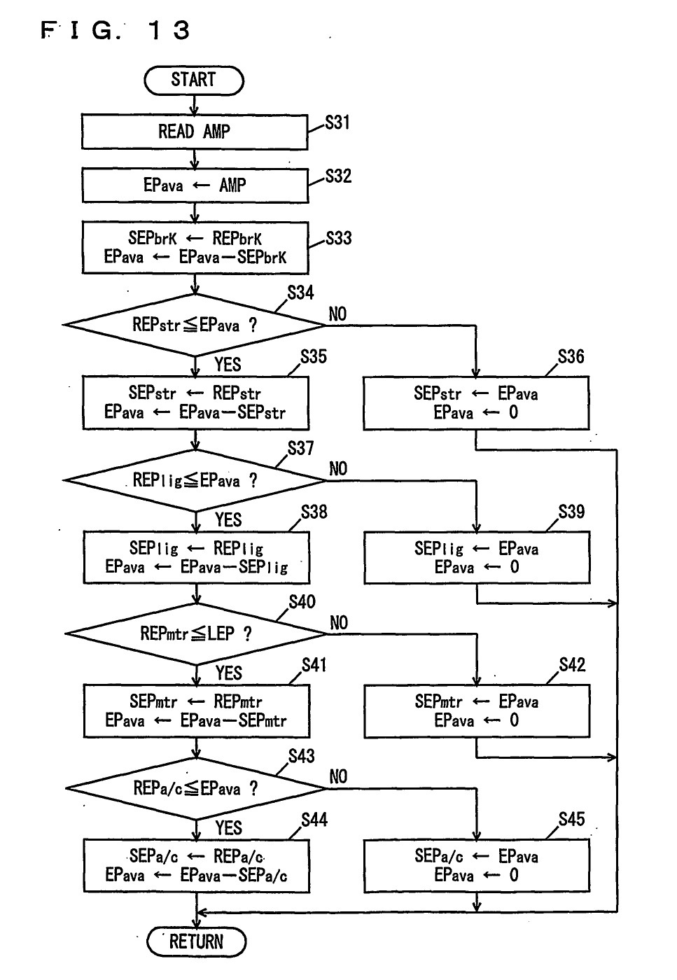

FIG. 13 is a flow chart schematically representing the details of S14 as a power limiting routine.

In the power limiting routine, first, in S31, the allowable power AMP is read from RAM 206, and in S32, as a value equal to the read allowable power AMP, available electric power EPava that can be supplied from electric power source 98 is set.

Thereafter, in S33, the required electric power REPbrk calculated for brake actuator 50 is set, as it is, to be the supplied electric power SEPbrk for brake actuator 50, and the supplied electric power SEPbrk is subtracted from the available electric power EPava, so that the available electric power EPava is updated.

Thereafter, in S34, whether the required electric power REPstr calculated for steering actuator 54 is equal to or smaller than the present available electric power EPava or not is determined.

When the required electric power REPstr is equal to or smaller than the available electric power EPava, the determination of S34 is YES, so that in S35, the required electric power REPstr is set, as it is, to be the supplied electric power SEPstr for steering actuator 54, and the supplied electric power SEPstr is subtracted from the current value of the available electric power EPava, so that the available electric power EPava is updated.

In contrast, when the required electric power REPstr is larger than the current value of available electric power EPava, the determination of S34 is NO, and in S36, the available electric power EPava is set, as it is, to be the supplied electric power SEPstr for the steering actuator 54, and the available electric power EPava is updated to 0. Immediately thereafter, one execution of the power limiting routine is terminated.

Thereafter, in S37, whether the required electric power REPlig calculated for light 70 is equal to or smaller than the current value of available electric power EVava is determined.

When the required electric power REPlig is equal to or smaller than the current value of the available electric power EPava, the determination of S37 is YES, and in S38, the required electric power REPlig is set, as it is, to be the supplied electric power SEPlig for light 70, and the supplied electric power SEPlig is subtracted from the current value of the available electric power EPava so that the available electric power EPava is updated.

In contrast, when the required electric power REPlig is larger than the current value of the available electric power EPava, the determination of S37 is NO, and in S39, the available electric power EPava is set, as it is, to be the supplied electric power SEPlig for light 70, and the available electric power EPava is updated to 0. Immediately thereafter, one execution of the power limiting routine is terminated.

Thereafter, in S40 to S42, supplied electric power SEPmtr for vehicle motor 58 is determined.

It is possible that operation of the brake becomes necessary during acceleration of the vehicle by vehicle motor 58. When the amount of electric energy that can be consumed by vehicle motor 58 is determined without considering such a possibility, actual brake operation would be difficult when necessary.

On the contrary, when the vehicle velocity is high and the number of rotation of vehicle motor 58 is high, regenerating brakeage by vehicle motor 58 occurs when the brake is operated, and accordingly, electric power source 98 is charged. The effect of charging is higher when the vehicle velocity is higher.

Therefore, in S40, in order to secure electric energy to be ready for potential operation of the brake, a preserved electric power PEP to be preserved for the potential operation of the brake is subtracted from the current value of the available electric power EPava, and thus, a lessened electric power LEP is calculated for vehicle motor 58. The preserved electric power PEP is defined as a function of the vehicle such that it decreases as the vehicle velocity increases.

Further, in S40, whether the required electric power REPmtr calculated for vehicle motor 58 is equal to or smaller than the calculated lessened electric power LEP or not is determined.

When the required electric power REPmtr is equal to or smaller than the lessened electric power LEP, the determination of S40 is YES, and in S41, the required electric power REPmtr is set, as it is, to be the supplied electric power SEPmtr for the vehicle motor 58, and the supplied electric power SEPmtr is subtracted from available electric power EPava so that the available electric power EPava is updated.

On the contrary, when the required electric power REPmtr is larger than the lessened electric power LEP, the determination of S40 is NO, and in S42, the available electric power EPava is set, as it is, to be the supplied electric power SEPmtr for vehicle motor 58, and the available electric power EPava is updated to 0. Immediately thereafter, one execution of the power limiting routine is terminated.

Thereafter, in S43, whether the required electric power REPa/c for air conditioner actuator 74 is equal to or smaller than the current value of available electric power EPava or not is determined.

When the required electric power REPa/c is equal to or smaller than the current value of available electric power EPava, the determination of S43 is YES, and in S44, the required electric power REPa/c is set, as it is, to be the supplied electric power SEPa/c for the air conditioner actuator 74, and the supplied electric power SEPa/c is subtracted from the current value of available electric power EPava so that the available electric power EPava is updated.

On the contrary, when the required electric power REPa/c is larger than the current value of available electric power EPava, the determination of S43 is NO, and in S45, the available electric power EPava is set, as it is, to be the supplied electric power SEPa/c for air conditioner actuator 74, and the available electric power EPava is updated to 0.

In any case, one execution of the power limiting routine is terminated here.

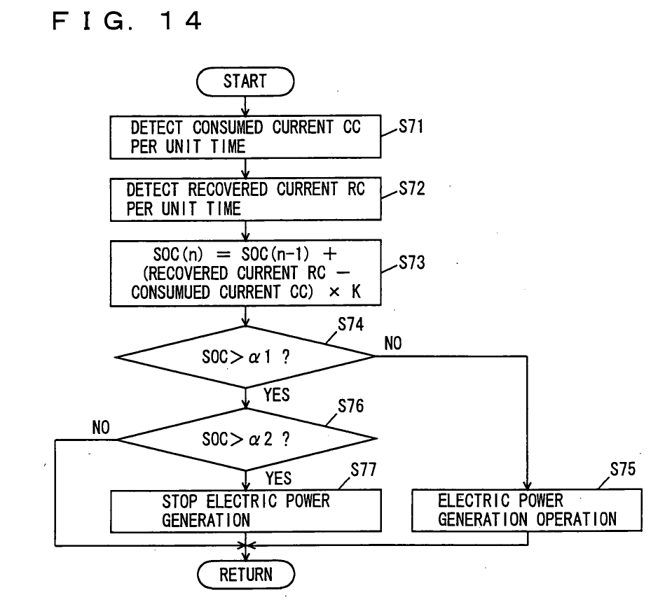

FIG. 14 is a flow chart schematically showing the contents of the electric power generation control program. The electric power generation control program is also executed repeatedly as computer 200 is on, similar to the general drive control program.

Every time the electric power generation control program is executed, first, in S71, electric power detectors 152, 162, 168, 176, 184 and 192 are used to detect the amount of current consumed at electric power source 98 per unit time, as consumed current CC. Next, in S72, using electric power detectors 104 and 106, the amount of current recovered by (charged to) electric power source 98 per unit time is detected as recovered current RC.

Thereafter, in S73, current value SOC(n) of the state of charge SOC is calculated as a sum of a product of current-SOC conversion factor K and the value obtained by subtracting the detected consumed current CC from the detected value of recovered current RC and the last value SOC(n−1) of the state of charge SOC. The calculated current value of SOC(n) is stored in a non-volatile storage portion of ROM 204 as the latest state of charge Soc.

Thereafter, in S74, whether the calculated current value SOC(n) is larger than a threshold value α1 or not is determined. When it is larger than α1, the determination is YES, and in S76, whether the current value SOC(n) is larger than a threshold value α2 larger than α1 or not is determined. When it is larger than α2, the determination is YES, and in S77, electric power generation by fuel cell 96 is stopped.

In contrast, when the current value SOC(n) is not larger than the threshold value α1, the determination of S74 is NO, and electric power generation by fuel cell 96 is executed in S75. When the current value SOC(n) is larger than the threshold value α1 but not larger than the threshold value α2, the determination of S74 is YES and the determination of S76 is NO, and steps S75 and S77 are skipped. As a result, electric power generation by fuel cell 96 is maintained in the same state as before.

Thus, one execution of the electric power generation control program is terminated.

It is additionally noted that the threshold values α1 and α2 mentioned above may be set both as fixed values or variable values. In the latter case, it may be possible to set each of the threshold values α1 and α2 as variable values that become smaller as the consumed current CC increases, or set as variable values that become smaller as the vehicle velocity decreases, based on the fact that the expected amount of current recovered to electric power source 98 by regeneration becomes smaller as the vehicle velocity is slower.

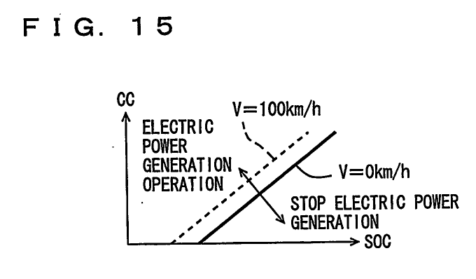

FIG. 15 is a graph schematically showing the relation that holds between each of state of charge SOC, consumed current CC, vehicle velocity V and presence/absence of electric power generation, when each of the threshold values α1 and α2 is set as variable values, as mentioned above.

As is apparent from the graph, here, when the state of charge SOC is the same, execution of electric power generation becomes more likely when the consumed current CC becomes larger, and it becomes more likely when the vehicle velocity is smaller.

When the consumed current CC is the same, execution of electric power generation becomes more likely when state of charge SOC is smaller, and it becomes more likely when the vehicle velocity is smaller.

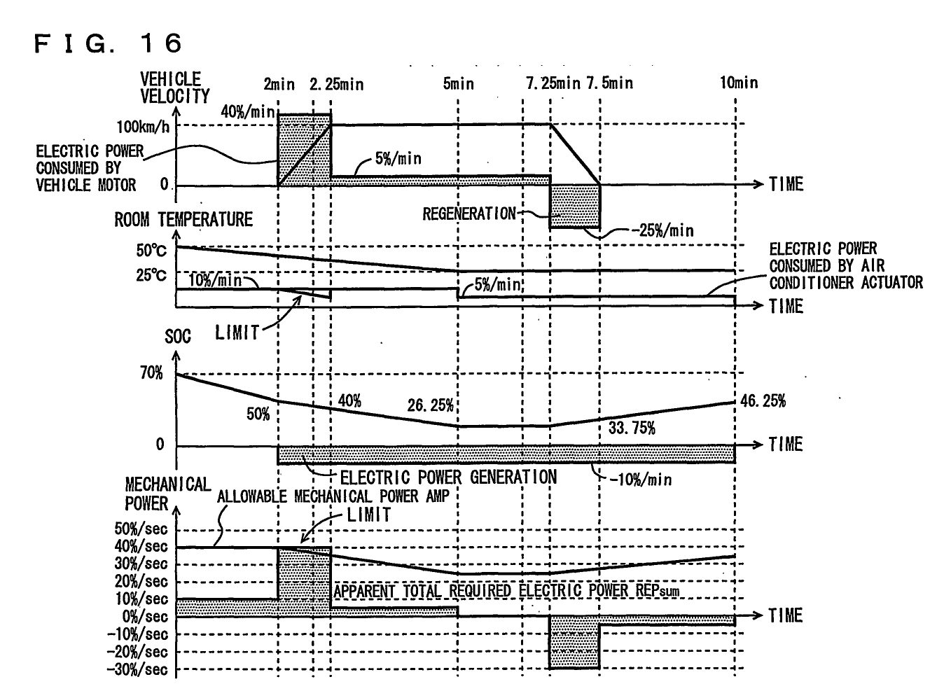

FIG. 16 shows, in same graphs, exemplary manner how the electric power consumption by vehicle motor 58 and air conditioner actuator 74, allowable power AMP and total required electric power REPsum change with time, when the general drive control program and the electric power generation control program are executed under specific condition with respect to vehicle velocity V, temperature T and state of charge SOC.

The specific conditions are as follows.

(1) Condition Related to Vehicle Velocity V
a. Stationary period

In accordance with the driver's instruction, for two minutes after the running switch of the vehicle is turned on, the vehicle is kept at a stationary state.
b. Acceleration period

Thereafter, the vehicle is accelerated such that the vehicle velocity increases from 0 km/h to 100 km/h with the acceleration of about 0.2 G in 0.25 min.
c. Steady running period

After the end of the acceleration, the vehicle is kept running steady, to maintain the vehicle velocity of 100 km/h.
d. Deceleration period

After the end of the steady running period, the vehicle is decelerated such that the vehicle velocity is decreased from 100 km/h to 0 km/h with the deceleration of about 0.2 G in 0.25 min.

(2) Condition Related to Temperature T
a. The atmospheric temperature is 35° C.
b. Room temperature of the vehicle is 50° C. in the initial state, and simultaneously with turning on of the running switch of the vehicle, the target temperature of 25° C. is set.

(3) Condition Related to the State of Charge SOC
a. Initial value

The initial value of state of charge SOC is 70%.
b. Amount of decrease of state of charge SOC (gradient of decrease)
   In the acceleration period, state of charge SOC decreases by 40% per minute.
   In the steady running period, state of charge SOC decreases by 5% per minute.
   While the air conditioner is in operation, state of charge SOC decreases by 10% per minutes in a transitional state of operation to attain the target room temperature (in which the room temperature decreases by 5° C. per minute), and state of charge SOC decreases by 5% per minute in a steady state after the target room temperature is reached.
c. Amount of increase of state of charge SOC (gradient of increase)
   During electric power generation, state of charge SOC increases by 10% per minute. Here, it is noted that said threshold values α1 and α2 are set to 50% and 60%, respectively.
   During regeneration, state of charge SOC increases by 25% per minute.

According to FIG. 16, as the vehicle running switch is turned on, the operation of the air conditioner starts, and as a result, the room temperature decreases and state of charge SOC decreases accordingly.

In the stationary period of the vehicle, air conditioner actuator 74 only consumes electric power, and therefore, the consumed electric power is equal to the total required electric power REPsum, and allowable power AMP is maintained at 40%/sec.

When the state of charge SOC decreases to be lower than 50%, electric power generation starts, and gradient of decrease of the state of charge SOC becomes moderate. At this time, the allowable power AMP is limited and, as a result, electric power consumption by air conditioner actuator 74 is limited.

Two minutes after the turning-on of the vehicle running switch, driving of vehicle motor 58 starts, and acceleration of the vehicle starts. Then, the total required electric power REPsum is the sum of electric power consumed by vehicle motor 58 and electric power consumed by air conditioner actuator 74 minus generated electric power. In the acceleration period, state of charge SOC decreases and allowable power AMP also decreases accordingly.

When the acceleration period ends and steady running period starts, electric power consumption by vehicle motor 58 decreases, and by that amount, the total required electric power REPsum decreases. In the steady running period, the total required power REPsum is the sum of electric power consumed by vehicle motor 58 for steady running and the electric power consumed by air conditioner actuator 74 minus the generated electric power. When the total required electric power REPsum decreases to be lower than the allowable power AMP, limit on the power of air conditioner actuator 74 is cancelled.

When the target room temperature is reached; air conditioner actuator 74 enters a normal operation, and electric power consumed by air conditioner actuator 74 decreases.

When state of charge SOC changes from decrease to increase in the steady running period, allowable power AMP also changes from decrease to increase.

When the steady running state ends and the deceleration period starts, vehicle motor 58 operates as an electric power generator, and regenerative brakeage takes place. In the deceleration period, total required electric power REPsum is the electric power consumed by air conditioner actuator 74 minus the sum of the regenerated electric power and the generated electric power.

As is apparent from the description above, in the present embodiment, master ECU 18 and the plurality of individual ECUs 20, 22 co-operate to form an example of the “control apparatus” in accordance with aspect (1) above.

Further, in the present embodiment, driving information detector 16 and that portion of master ECU 18 which executes S1 to S4 of FIG. 7 co-operate to form an example of the “driving request determining apparatus” in accordance with aspect (5) above, and that portion of master ECU 18 which executes S1 to S4 of FIG. 7 forms an example of the “driving request determining means” in accordance with aspect (6) above.

Further, in the present embodiment, that portion of master ECU 18 which executes S6 of FIG. 7 constitutes an example of “desired power determining means” in accordance with aspect (8) above, that portion which executes S7 of the same figure constitutes the “required electric power determining means” of the same aspect, that portion which executes S8 to S10 and S14 of the same figure constitutes an example of the “desired power establishing means” of the same aspect, and that portion which executes S11 to S13 of the same figure constitutes an example of the “driving means” of the same aspect.

Further, in the present embodiment, that portion of master ECU 18 which executes S14 of FIG. 7 constitutes an example of the “desired power establishing means” in accordance with aspect (9) above, and that portion which executes S11 to S13 of the same figure constitutes an example of the “driving means” in accordance with aspect (12).

Further, in the present embodiment, that portion of master ECU 18 which executes S5 and S9 of FIG. 7 constitutes an example of the “control mode changing means” in accordance with aspect (13) or (14) above, and that portion which executes S11 to S13 of the same figure constitutes an example of the “driving means” in accordance with aspect (12).

Further, in the present embodiment, that portion of master ECU 18 which executes S8 of FIG. 7 constitutes an example of the “apparent value determining means” in accordance with aspect (15) above, and that portion which executes S10 of the same figure constitutes an example of the “control means” of the same aspect.

Further, in the present embodiment, master ECU 18 constitutes an example of the “master control unit” in accordance with aspect (16) or (17), and the plurality of individual ECUs 20, 22 constitute examples of the “plurality of individual control units” in accordance with aspect (18) above.

Further, in the present embodiment, input energy detectors 24, 26 and output energy detectors 28, 30 each constitute an example of the “energy detector” in accordance with aspect (19) above.

Further, in the present embodiment, S6 to S14 of FIG. 7 together constitute an example of the “control step” in accordance with aspect (22) or (23) above.

Next, a second embodiment of the present invention will be described. It is noted, however, that the hardware configuration of the present embodiment is common to that of the first embodiment, and the software configuration is also common, except for the power limiting routine. Therefore, only the power limiting routine will be described in detail, and the description of the common components will not be repeated, as the description of the first embodiment is applicable.

A vehicle having the general drive control system in accordance with the present embodiment includes, as in the first embodiment, brake actuator 50, steering actuator 54, vehicle motor 58 and CVT motor 66, light 70 and air conditioner actuator 74, as the plurality of actuators.

In the first embodiment, priority is set in accordance with the order among the plurality of actuators, and available electric power is distributed to each of the actuators in accordance with the priority order.

It is considered that among the plurality of actuators, air conditioner actuator 74 is of the lowest priority as regards the necessity to meet the request of operation thereof. It is particularly true in a vehicle, where safety of the vehicle is of higher importance than comfort of those who in the vehicle.

Therefore, in the present embodiment, the plurality of actuators are divided into air conditioner actuator 74 and other actuators. Further, when the total required electric power REPsum exceeds the allowable power AMP, whether the value that is the total required electric power REPsum minus required electric power REPa/c of air conditioner actuator, that is, the major required electric power MREP, is equal to or smaller than the allowable power AMP or not is determined.

When the major required electric power MREP is equal to or smaller than the allowable power AMP, electric power equal to the required electric power REP is supplied to each of the actuators other than the air conditioner actuator 74, and electric power that is equal to the available electric power EPava that is equal to the allowable power AMP minus major required electric power MREP, is supplied to air conditioner actuator 74.

In contrast, when the major required electric power MREP exceeds the allowable power AMP, available electric power EPava is distributed with appropriate ratio to respective ones of the actuators except for air conditioner actuator 74, and no electric power is supplied to air conditioner actuator 74.

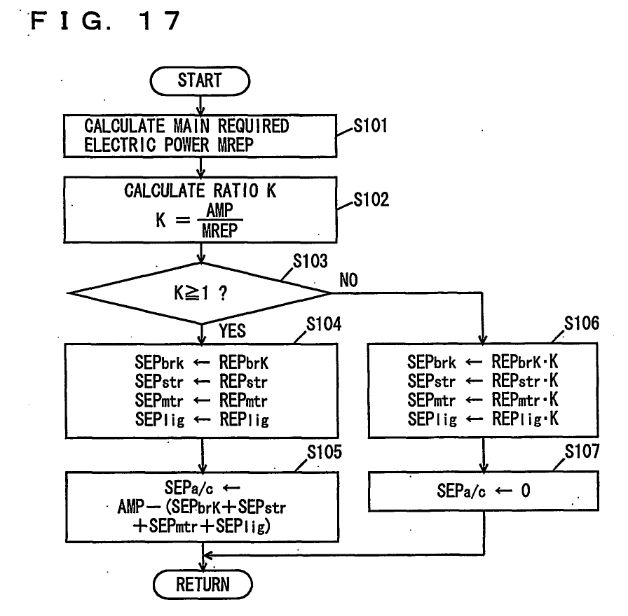

FIG. 17 is a flow chart schematically showing the contents of the power limiting routine realizing the algorithm described above.

In the power limiting routine, first, in S101, the required electric power REPa/c of air conditioner actuator 74 is subtracted from the total required electric power REPsum, to obtain the major required electric power MREP. Next, in S102, the allowable power AMP is divided by the thus obtained major required electric power MREP, to obtain a ratio K.

Thereafter, in S103, whether the thus calculated ratio K is equal to or larger than 1 or not is determined. Namely, whether the major required electric power MREP is equal to or smaller than the allowable power AMP or not is determined.

Here, assuming that the ratio K is equal to or larger than 1, the determination at S103 is YES, and in S104, supplied electric power SEP to each of the actuators except for air conditioner actuator 74 is determined to be equal to the corresponding required electric power REP. Then, in S105, the sum of supplied electric powers SEP to all the actuators except for air conditioner actuator 74 is subtracted from allowable power AMP, and thus, the supplied electric power SEPa/c to air conditioner actuator 74 is calculated.

Assuming that the ratio K is smaller than 1, the determination of S103 is NO. Then, in S106, supplied electric power SEP to each of the actuators except for air conditioner actuator 74 is determined to be a value equal to the product of corresponding required electric power REP and the ratio K. Next, in S107, supplied electric power SEPa/c to air conditioner actuator 74 is determined to be 0.

In any case, through these steps, one execution of the power limiting routine is terminated.

Next, a third embodiment of the present invention will be described. It is noted, however, that the hardware configuration of the present embodiment is common to that of the first embodiment, and the software configuration is also common, except for the power limiting routine. Therefore, only the power limiting routine will be described in detail, and the description of the common components will not be repeated, as the description of the first embodiment is applicable.

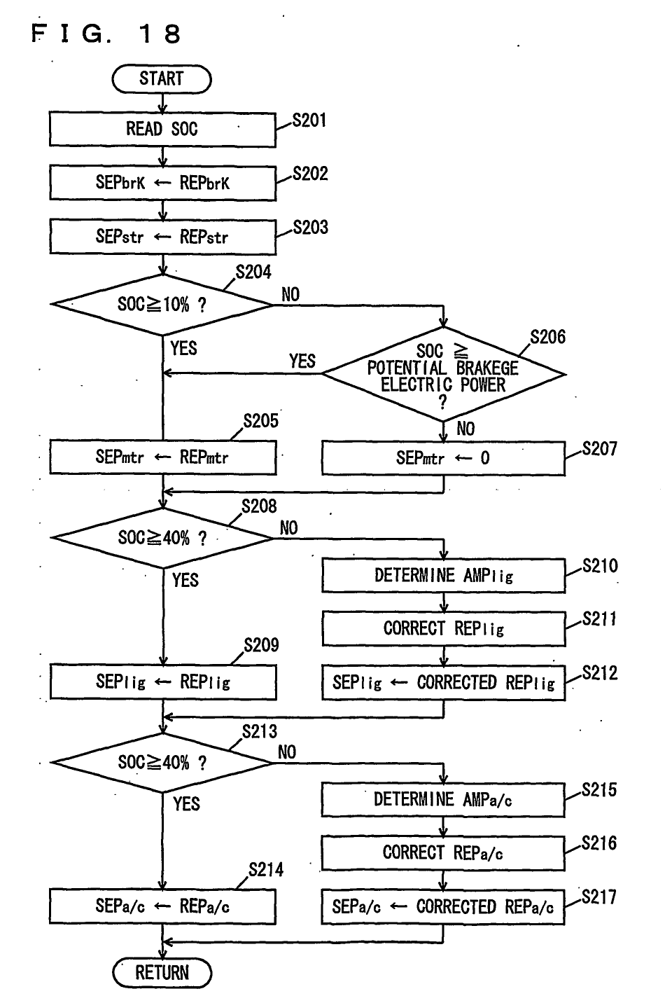

FIG. 18 is a flow chart schematically representing the contents of the power limiting routine executed by a computer 200 of master ECU18 in the general drive control system in accordance with the present embodiment.

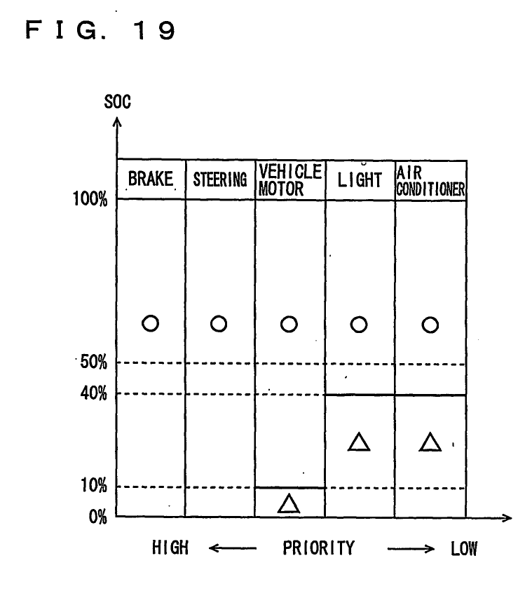

In FIG. 19, names of five actuators mentioned above are listed from left to right in accordance with the order of priority, with the manner how the power of each actuator is limited in accordance with the state of charge SOC shown in the form of a graph.

As can be seen from the graph, power of brake actuator 50 and steering actuator 54 are not limited, regardless of the state of charge SOC.

As to vehicle motor 58, in the range where the state of charge SOC is equal to or higher than a set value (for example, 10%), the power thereof is not limited regardless of the value of SOC, as shown in FIG. 19. In contrast, in a range where state of charge SOC is smaller than the set value, the power is not limited if the electric power potentially required for stopping the vehicle by using the brake (and, if necessary, additionally using the steering apparatus), that is, potential brakeage electric power is left in electric power source 98, and the power is limited if the potential electric power is not left in electric power source 98. In the latter case, the power is decreased, for example, to 0.

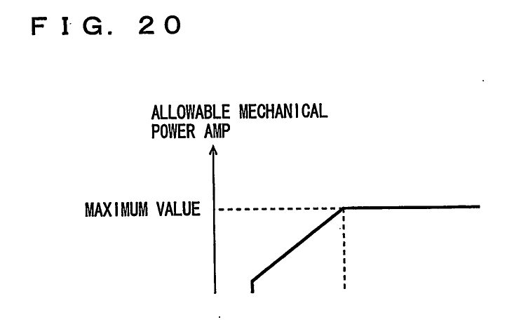

As for light 70 and air conditioner actuator 74, in the range where state of charge SOC is equal to or smaller than a set value (for example, 40%), the power is not limited regardless of the state of charge SOC, as shown in FIG. 19. In contrast, in the range where the state of charge SOC is smaller than the set value, the power is limited in accordance with state of charge SOC, as represented, for example, by a graph of FIG. 20.

The power limiting routine in accordance with the present embodiment will be described with reference to FIG. 18.

First, in S201, state of charge SOC is read from the non-volatile storage unit mentioned above. Then, in S202, the required electric power REPbrk for brake actuator 50 calculated in accordance with the general drive control program is set, as it is, as the supplied electric power SEPbrk.

Thereafter, in S203, as in S202, the required electric power REPstr for steering actuator 54 calculated in accordance with the general drive control program is set, as it is, as the supplied electric power SEPstr.

Thereafter, in S204, whether the read state of charge SOC is equal to or higher than 10% is determined. When it is equal to or higher than 10%, the determination is YES, and in S205, the required electric power REPmtr for vehicle motor 58 calculated in accordance with the general drive control program is set, as it is, as the supplied electric power SEPmtr. On the contrary, when the state of charge SOC is smaller than 10%, the determination of S204 is NO, and the flow proceeds to S206.

In S206, whether state of charge SOC is equal to or higher than the potential brakeage electric power or not is determined. When it is equal to or higher than the potential brakeage electric power, the determination is YES, and the flow proceeds to S205. When it is smaller than potential brakeage electric power, the determination is NO, and the supplied electric power SEPmtr is set to 0 in S207.

In any case, the flow proceeds to S208, in which whether the read state of charge SOC is equal to or higher than 40% or not is determined. When it is equal to or higher than 40%, the determination is YES, and in S209, the required electric power REPlig for light 70 calculated in accordance with the general drive control program is set, as it is, to be the supplied electric power SEPlig. When the state of charge SOC is smaller than 40%, the determination of S208 is NO, and the flow proceeds to S210.

In S210, allowable power AMP of light 70 is determined in accordance with a pattern shown by the graph of FIG. 20, for example, dependent on the state of charge SOC. Thereafter, in S211, the calculated value of required electric power REPlig is corrected so that the actual power does not exceed the determined allowable power AMPlig. It is noted that, by this correction, the required electric power REPlig may be decreased.

Thereafter, in S212, the supplied electric power SEPlig is determined to be equal to the corrected required electric power REPlig.

In any case, S213 to 217 are thereafter executed for air conditioner actuator 74 in the similar manner as S208 to S212.

Specifically, in S213, whether the state of charge SOC is equal to or higher than 40% or not is determined. When it is equal to or higher than 40%, the required electric power REPa/c is set as it is, as supplied electric power SEPa/c in S214. When state of charge SOC is smaller than 40%, the flow proceeds to S215.

In S215, allowable power AMPa/c for air conditioner actuator 74 is determined in accordance with a pattern shown by the graph of FIG. 20, for example, dependent on the state of charge SOC. Thereafter, in S216, the calculated value of required electric power REPa/c is corrected so that the actual power does not exceed the determined allowable power AMPa/c. It is noted that, by this correction, the required electric power REPa/c may be decreased.

Thereafter, in S217, the supplied electric power SEPa/c is determined to be equal to the corrected required electric power REPa/c.

In any case, through these steps, one execution of the power limiting routine is terminated.

Next, the fourth embodiment of the present invention will be described. It is noted, however, that the hardware configuration of the present embodiment is common to that of the first embodiment, and therefore, only the software configuration will be described in detail, and the description of the hardware configuration will not be repeated as the description of the first embodiment is applicable.

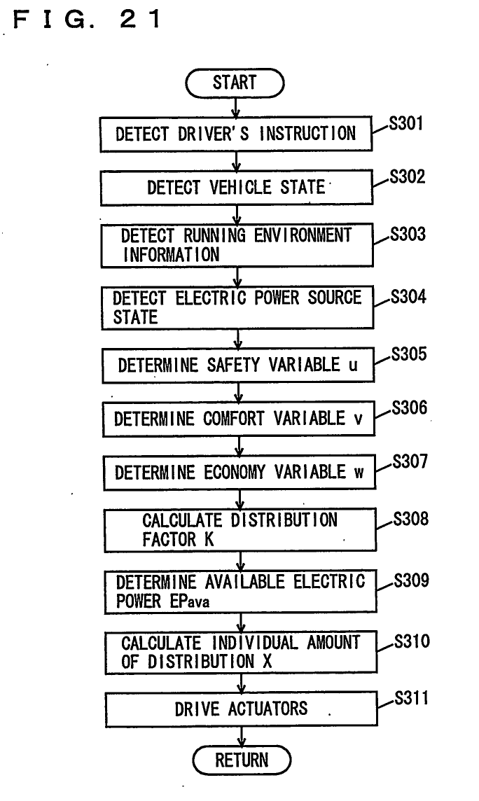

FIG. 21 is a flow chart schematically showing the contents of the general drive control program executed by computer 200 of master ECU18 in the general drive control system in accordance with the present embodiment.

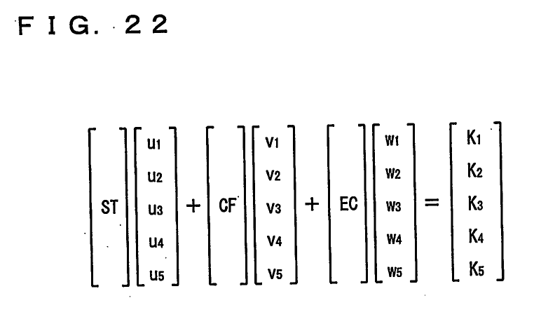

In the present embodiment, relation between each of a safety variable u related to the safety of the vehicle as a moving body, a comfort variable v related to comfort when a human being uses the vehicle, an economy variable w related to economy of energy consumption by the plurality of actuators mounted on the vehicle, and a distribution ratio K used when the available power that can be supplied by the energy source 14 to the plurality of actuators as a whole is distributed to the plurality of actuators, is given in the form of a matrix of target function, in FIG. 22.

In the target function, a safety factor ST for the safety variable u, a comfort factor CF for the comfort variable v, and an economy factor EC for economy variable w are defined. These factors ST, CF and EC have preset values.

Therefore, in the present embodiment, by inputting current values of safety variable u, comfort variable b and economy variable w to the target function, the distribution ratio K is calculated for each actuator.

Further, in the present embodiment, based on the driver's instruction detected by the driver's instruction sensor 90, the vehicle state detected by the vehicle state sensor 92, the running environment information detected by the running environment information sensor 94 and the state of electric power source 98 (including state of charge SOC, temperature, degree of degradation and the like), current values of safety variable u, comfort variable v and economy variable w are calculated.

Specifically, the safety variable u reflects the necessity how much higher priority is to be given to the safety of the vehicle, and therefore, it is determined based on the driver's instruction that is related to running of the vehicle, the vehicle state that is related to stability of vehicle behavior and the running environment information related to the follow distance.

Further, comfort variable v reflects the necessity how much higher priority is to be given to the comfort of the vehicle than other elements, and therefore, it is determined based on the driver's instruction that is related to room temperature, running environment information that is related to atmospheric temperature, and so on.

Further, economy variable w reflects the necessity how much higher priority is to be given to the economy of the vehicle than other elements, and therefore, it is determined based on the driver's instruction that is related to economy of the vehicle (for example, whether the driver selects the economy mode or power-mode described above), the discharging capability of electric power source 98 and the like.

The contents of the general drive control program will be described with reference to FIG. 21.

The general drive control program is executed repeatedly. Every time the program is executed, first, in S301 to S303, the driver's instruction, the vehicle state and the running environment information are detected by driver's instruction sensor 90, vehicle state sensor 92 and running environment information sensor 94.

Thereafter, in S304, the state of electric power source 98 is detected. By way of example, the state of charge SOC is detected as in the first embodiment, and the temperature or degree of degradation of electric power source 98 is detected.

Thereafter, in S305 to S307, safety variable u, comfort variable v and economy variable w are determined respectively, in the above described manner.

Thereafter, in S308, the determined safety variable u, comfort variable v and economy variable w are input to the target function, whereby the distribution factor K is calculated for each actuator.

Thereafter, in S309, the available electric power EPava that can be supplied by electric power source 98 is determined. The available electric power EPava is determined, by way of example, based on the state of electric power source 98 including the state of charge SOC. For this purpose, a predetermined relation between the available electric power EPava and the state of charge SOC, for example, is stored in ROM 204.

Thereafter, in S310, for each actuator, an individual distribution X is calculated as a product of available electric power EPava and the distribution ratio K. Then, in S311, each actuator is driven with the calculated individual distribution.

Through these steps, one execution of the general drive control program is terminated.

As is apparent from the foregoing, in the present embodiment, S305 to S310 of FIG. 21 together constitute an example of the “distributing step” in accordance with aspect (24) above.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

As described above, according to the vehicle general control system, from the viewpoint of power or work of each of the plurality of actuators, drive of these actuators is generally controlled. Between the power or the work and energy consumption of each actuator, there is a relation that the smaller the power or work, the smaller the necessary energy consumption. Therefore, according to this system, as the power or work of each actuator is considered, it becomes possible to optimize the drive of the plurality of actuators, from the viewpoint of saving energy consumed by the plurality of actuators. Therefore, the general drive control system in accordance with the present invention is suitable for a motor vehicle having an internal combustion engine, a hybrid motor vehicle, an electric vehicle, a motor vehicle with fuel cell and the like.

1. A general drive control system provided in a vehicle including a plurality of actuators and an energy source common to the actuators, accomplishing a work by an operation of said plurality of actuators consuming energy supplied by said energy source, comprising a control apparatus generally controlling drive of said plurality of actuators, with amount of drive of each of the plurality of actuators being determined in a dimension of work or power as work per unit time.

2. The general drive control system according to claim 1, wherein a target value of each actuator is represented and determined in a dimension of power or work from a drive request, and said control apparatus generally controls drive of said plurality of actuators based on a target power or target work as the determined target value.

3. The general drive control system according to claim 1, wherein a drive request and each actuator are related to each other in a dimension of power or work, and said control apparatus generally controls drive of said plurality of actuators based on the power or work.

4. (canceled)

5. The general drive control system according to claim 1, wherein said plurality of actuators are of mutually different type.

6. The general drive control system according to claim 1, wherein
said control apparatus generally controls drive of said plurality of actuators based on a total power or a total work that is a sum of power or work approximately at the same time period, of said plurality of actuators.

7. The general drive control system according to claim 1, wherein
said control apparatus generally controls drive of said plurality of actuators such that said power or work of each of said actuators or said total power or total work of said plurality of actuators does not exceed an allowable value.

8. The general drive control system according to claim 7, wherein
said control apparatus includes a power limiting unit limiting, when said total power or total work is about to exceed said allowable value, power of at least a part of said plurality of actuators in accordance with an order set in advance for said plurality of actuators.

9. The general drive control systems according to claim 1, further comprising
a driving request determining apparatus determining a driving request for said vehicle; wherein
said control apparatus determines said power or said work based on the determined driving request as a desired power or desired work, and generally controls drive of said plurality of actuators based on the determined desired power or desired work.

10. The general drive control system according to claim 9, wherein
said driving request determining apparatus includes
a driving information detector detecting at least one of a driver's instruction driving said vehicle, state of operation of said vehicle, and operation environment in which said vehicle is placed, as driving information, and
a driving request determining unit determining said driving request based on the detected driving information; and
said control apparatus generally controls drive of said plurality of actuators based on said power or work based on the determined driving request.

11. The general drive control system according to claim 9, wherein
said control apparatus determines, based on said determined driving request, said power or work to meet the driving request as a desired power or desired work for each of said actuators, and based on the determined desired power or desired work, generally controls drive of said plurality of actuators.

12. The general drive control system according to claim 9, wherein
said control apparatus includes
a desired power determining unit determining, for each of said actuators, power to meet said determined driving request as a desired power;
a required electric power determining unit determining required electric power to be supplied to each actuator to realize the desired power determined for each of said actuators;
a desired power establishing unit establishing, when a total required electric power as a sum of required electric power determined for the plurality of actuators exceeds said allowable value, desired power for each of the plurality of actuators by decreasing corresponding desired power of some of said plurality of actuators; and
a driving unit driving said plurality of actuators based on the established desired power.

13. The general drive control system according to claim 12, wherein
said desired power establishing unit decreases desired power determined for some of said actuators, in accordance with an order set in advance for said plurality of actuators, when said total required electric power exceeds said allowable value.

14-16. (canceled)

17. The general drive control system according to claim 7, wherein
said control apparatus includes a control mode changing unit manually or automatically changing said allowable value, thereby changing control mode for controlling said plurality of actuators.

18. The general drive control system according to claim 17, wherein
said control mode changing unit selects as said control mode an economy mode in which saving of energy consumed by said plurality of actuators is given higher priority than realization of a target state of operation of said vehicle, by setting said allowable value to a small value, in a normal state of operation of said vehicle, and selects as said control mode a power-mode in which realization of the target state of operation of said vehicle is given higher priority than said saving of energy consumption, by setting said allowable value to a large value, in an emergency state of operation of said vehicle, and
said control apparatus generally controls drive of said plurality of actuators in accordance with the selected control mode.

19. The general drive control system according to claim 1, wherein
said plurality of actuators constitute a consumption unit consuming energy supplied from said energy source;
said energy source includes
a generating unit generating said energy, and
a storage unit storing the generated energy; and
said control apparatus includes
an apparent value determining unit determining an apparent value of said power or said work based on actual power or actual work of each of said actuators, energy generation ratio or energy generation amount by said generating unit, and energy storage ratio or storage amount by said storage unit, and
a control unit generally controlling drive of said plurality of actuators, based on the determined apparent value.

20-25. (canceled)

26. The general drive control system according to claim 1, wherein
said control apparatus generally controls drive of said plurality of actuators by distributing among the plurality of actuators, available power or available work, which is the power or work that can be supplied by said energy source to the plurality of actuators as a whole, based on a safety variable related to safety of said vehicle, a comfort variable related to comfort enjoyed by the human being using said vehicle, and an economy variable related to economy of energy consumption by said plurality of actuators.

27. A general drive control system provided in a vehicle including a plurality of actuators and an energy source common to the actuators, accomplishing a work by an operation of said plurality of actuators consuming energy supplied by said energy source, comprising
control means for generally controlling drive of said plurality of actuators, with amount of drive of each of the plurality of actuators being determined in a dimension of work or power as work per unit time.

28. The general drive control system according to claim 27, wherein a target value of each actuator is represented and determined in a dimension of power or work from a drive request, and said control means includes means for generally controlling drive of said plurality of actuators based on a target power or target work as the determined target value.

29. The general drive control system according to claim 27, wherein a drive request and each actuator are related to each other in a dimension of power or work, and said control apparatus includes means for generally controlling drive of said plurality of actuators based on the power or work.

30. (canceled)

31. The general drive control system according to claim 27, wherein
said plurality of actuators are of mutually different type.

32. The general drive control system according to claim 27, wherein
said control means includes means for generally controlling drive of said plurality of actuators based on a total power or a total work that is a sum of power or work approximately at the same time period, of said plurality of actuators.

33. The general drive control system according to claim 27, wherein
said control means includes means for generally controlling drive of said plurality of actuators such that said power or work of each of said actuators or said total power or total work of said plurality of actuators does not exceed an allowable value.

34. The general drive control system according to claim 33, wherein
said control means includes
power limiting means for limiting, when said total power or total work is about to exceed said allowable value, power of at least a part of said plurality of actuators in accordance with an order set in advance for said plurality of actuators.

35. The general drive control system according to claim 27, further comprising
driving request determining means for determining a driving request for said vehicle; wherein
said control means includes means for determining said power or said work based on the determined driving request as a desired power or desired work, and for generally controlling drive of said plurality of actuators based on the determined desired power or desired work.

36. The general drive control system according to claim 35, wherein
said driving request determining means includes
driving information detecting means for detecting at least one of a driver's instruction driving said vehicle, state of operation of said vehicle, and operation environment in which said vehicle is placed, as driving information, and
driving request determining means for determining said driving request based on the detected driving information; and
said control means includes means for generally controlling drive of said plurality of actuators based on said power or work based on the determined driving request.

37. The general drive control system according to claim 36, wherein
said control apparatus includes means for determining, based on said determined driving request, said power or work to meet the driving request as a desired power or desired work for each of said actuators, and based on the determined desired power or desired work, for generally controlling drive of said plurality of actuators.

38. The general drive control system according to claim 35, wherein
said control means includes
desired power determining means for determining, for each of said actuators, power to meet said determined driving request as a desired power;
required electric power determining means for determining required electric power to be supplied to each actuator to realize the desired power determined for each of said actuators;
desired power establishing means for establishing, when a total required electric power as a sum of required electric powers determined for the plurality of actuators exceeds said allowable value, desired power for each of the plurality of actuators by decreasing corresponding desired power of some of said plurality of actuators; and
driving means for driving said plurality of actuators based on the established desired power.

39. The general drive control system according to claim 38, wherein
said desired power establishing means includes means for decreasing desired power determined for some of said actuators, in accordance with an order set in advance for said plurality of actuators, when said total required electric power exceeds said allowable value.

40-42. (canceled)

43. The general drive control system according to claim 33, wherein
said control means includes control mode changing means for manually or automatically changing said allowable value, thereby changing control mode for controlling said plurality of actuators.

44. The general drive control system according to claim 43, wherein
said control mode changing means includes means for selecting as said control mode an economy mode in which saving of energy consumed by said plurality of actuators is given higher priority than realization of a target state of operation of said vehicle, by setting said allowable value to a small value, in a normal state of operation of said vehicle, and for selecting as said control mode a power-mode in which realization of the target state of operation of said vehicle is given higher priority than said saving of energy consumption, by setting said allowable value to a large value, in an emergency state of operation of said vehicle, and
said control means includes means for generally controlling drive of said plurality of actuators in accordance with the selected control mode.

45. The general drive control system according to claim 27, wherein
said plurality of actuators constitute a consumption unit consuming energy supplied from said energy source;
said energy source includes
a generating unit generating said energy, and
a storage unit storing the generated energy; and
said control means includes
apparent value determining means for determining an apparent value of said power or said work based on actual power or actual work of each of said actuators, energy generation ratio or energy generation amount by said generating unit, and energy storage ratio or storage amount by said storage unit, and
control means for generally controlling drive of said plurality of actuators.

46-51. (canceled)

52. The general drive control system according to claim 27, wherein
said control means includes means for generally controlling drive of said plurality of actuators by distributing among the plurality of actuators, available power or available work, which is the power or work that can be supplied by said energy source to the plurality of actuators as a whole, based on a safety variable related to safety of the vehicle, a comfort variable related to comfort enjoyed by the human being using the vehicle, and an economy variable related to economy of energy consumption by said plurality of actuators.

53. A general drive control method, implemented in a vehicle including a plurality of actuators and an energy source common to the actuators, for accomplishing a work by an operation of said plurality of actuators consuming energy supplied by said energy source, comprising the step of
generally controlling drive of said plurality of actuators, with amount of drive of each of the plurality of actuators being determined in a dimension of work or power as work per unit time.

54. The general drive control method according to claim 53, wherein a target value of each actuator is represented and determined in a dimension of power or work from a drive request, and said step of generally controlling drive of said plurality of actuators includes the step of generally controlling drive of said plurality of actuators based on a target power or target work as the determined target value.

55. The general drive control method according to claim 53, wherein a drive request and each actuator are related to each other in a dimension of power or work, and said step of generally controlling drive of said plurality of actuators includes the step of generally controlling drive of said plurality of actuators based on the power or work.

56. (canceled)

57. The general drive control method according to claim 53, wherein
said plurality of actuators are of mutually different type.

58. The general drive control method according to claim 53, wherein
said step of generally controlling drive of said actuators includes the step of controlling drive of said plurality of actuators based on a total power or a total work that is a sum of power or work approximately at the same time period, of said plurality of actuators.

59. The general drive control method according to claim 53, wherein
said step of generally controlling drive of said actuators includes the step of controlling drive of said plurality of actuators such that said power or work of each of said actuators or said total power or total work of said plurality of actuators does not exceed an allowable value.

60. The general drive control method according to claim 59, wherein
said step of generally controlling drive of said actuators includes the step of limiting, when said total power or total work is about to exceed said allowable value, power of at least a part of said plurality of actuators in accordance with an order set in advance for said plurality of actuators.

61. The general drive control method according to claim 53, further comprising the step of determining a driving request for said vehicle; wherein
said step of generally controlling drive of said actuators includes the step of determining said power or said work based on the determined driving request as a desired power or desired work, and controlling drive of said plurality of actuators based on the determined desired power or desired work.

62. The general drive control method according to claim 61, wherein
said driving request determining step includes the steps of
detecting at least one of a driver's instruction driving said vehicle, state of operation of said vehicle, and operation environment in which said vehicle is placed, as driving information, and
determining said driving request based on the detected driving information; and
said step of generally controlling drive of said actuators includes the step of controlling drive of said plurality of actuators based on said power or work based on the determined driving request.

63. The general drive control method according to claim 61, wherein
said step of generally controlling drive of said actuators includes the step of determining, based on said determined driving request, said power or work to meet the driving request as a desired power or desired work for each of said actuators, and based on the determined desired power or desired work, controlling drive of said plurality of actuators.

64. The general drive control method according to claim 61, wherein
said step of generally controlling drive of said actuators includes the steps of
determining, for each of said actuators, power to meet said determined driving request as a desired power;
determining required electric power to be supplied to each actuator to realize the desired power determined for each of said actuators, as required electric power;
establishing, when a total required electric power as a sum of required electric power determined for the plurality of actuators exceeds said allowable value, desired power for each of the plurality of actuators by decreasing corresponding desired power of some of said plurality of actuators; and
driving said plurality of actuators based on the established desired power.

65. The general drive control method according to claim 64, wherein
said step of establishing desired power includes the step of decreasing desired power determined for some of said actuators, in accordance with an order set in advance for said plurality of actuators, when said total required electric power exceeds said allowable value.

66-68. (canceled)

69. The general drive control method according to claim 59, wherein
said step of generally controlling drive of said actuators includes the step of manually or automatically changing said allowable value, thereby changing control mode for controlling said plurality of actuators.

70. The general drive control method according to claim 69, wherein
said step of changing control mode includes the step of selecting, as said control mode an economy mode in which saving of energy consumed by said plurality of actuators is given higher priority than realization of a target state of operation of said vehicle, by setting said allowable value to a small value, in a normal state of operation of said vehicle, and selecting, as said control mode a power-mode in which realization of the target state of operation of said vehicle is given higher priority than said saving of energy consumption, by setting said allowable value to a large value, in an emergency state of operation of said vehicle, and
said step of generally controlling drive of said actuators includes the step of controlling drive of said plurality of actuators in accordance with the selected control mode.

71. The general drive control method according to any of claim 53, wherein
said plurality of actuators constitute a consumption unit consuming energy supplied from said energy source;
said energy source includes
a generating unit generating said energy, and
a storage unit storing the generated energy; and
said step of generally controlling drive of said actuators includes the step of
determining an apparent value of said power or said work based on actual power or actual work of each of said actuators, energy generation ratio or energy generation amount by said generating unit, and energy storage ratio or storage amount by said storage unit, and
controlling drive of said plurality of actuators based on the determined apparent value.

72-77. (canceled)

78. The general drive control method according to claim 53, wherein
said step of generally controlling drive of said plurality of actuators includes the step of controlling drive of said plurality of actuators by distributing among the plurality of actuators, available power or available work, which is the power or work that can be supplied by said energy source to the plurality of actuators as a whole, based on a safety variable related to safety of the vehicle, a comfort variable related to comfort enjoyed by the human being using the vehicle, and an economy variable related to economy of energy consumption by said plurality of actuators.
